(19) United States
(12) Patent Application Publication
(10) Pub. No.: US 2025/0285808 A1
(43) Pub. Date: Sep. 11, 2025

(54) MULTILAYER CERAMIC CAPACITOR

(71) Applicant: Murata Manufacturing Co., Ltd., Nagaokakyo-shi (JP)

(72) Inventors: Jun KURITANI, Nagaokakyo-shi (JP); Tatsunori YASUDA, Nagaokakyo-shi (JP)

(21) Appl. No.: 19/215,440

(22) Filed: May 22, 2025

Related U.S. Application Data
(63) Continuation of application No. PCT/JP2023/044761, filed on Dec. 14, 2023.

(30) Foreign Application Priority Data
Feb. 22, 2023 (JP) 2023-025769

(51) Int. Cl. H01G 4/232; H01G 4/008; H01G 4/012; H01G 4/12; H01G 4/33

(52) U.S. Cl. CPC H01G 4/232; H01G 4/0085; H01G 4/012; H01G 4/12; H01G 4/33

(57) ABSTRACT

A multilayer ceramic capacitor includes a multilayer body including laminated dielectric layers, first and second main surfaces opposite each other in a height direction, first and second side surfaces opposite each other in a width direction, first and second end surfaces opposite each other in a length direction, first inner electrode layers alternately laminated with the dielectric layers and exposed at the first end surface, second inner electrode layers alternately laminated with the dielectric layers and exposed at the second end surface, a first outer electrode on the first end surface, and a second outer electrode on the second end surface. The first and second end surfaces are curved from the first main surface to the second main surface with a radius of curvature of about 5/2 or less of a thickness of the multilayer body at a central portion of the multilayer body in the length direction.

### CROSS REFERENCE TO RELATED APPLICATIONS

This application claims the benefit of priority to Japanese Patent Application No. 2023-025769 filed on Feb. 22, 2023 and is a Continuation Application of PCT Application No. PCT/JP2023/044761 filed on Dec. 14, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, with the miniaturization of electronic devices on which multilayer ceramic capacitors are mounted, the dimensions of electronic components have also been reduced.

There is a problem in that the outer electrodes of a multilayer ceramic capacitor can peel off from the multilayer chip when a device including a multilayer ceramic capacitor, for example, a smartphone, is dropped from a certain height or subjected to distortion from a substrate.

For example, Japanese Unexamined Patent Application Publication No. 2018-182107 discloses a technique in which a glass component layer is disposed between a multilayer chip and an outer electrode to increase the bonding strength between the multilayer chip and the outer electrode.

### SUMMARY OF THE INVENTION

However, when a glass component layer is disposed between a multilayer chip and an outer electrode, as in Japanese Unexamined Patent Application Publication No. 2018-182107, the inner electrodes are covered with the glass component, which may increase the equivalent series resistance (ESR).

Example embodiments of the present invention provide multilayer ceramic capacitors that each achieve improved adhesive strength between a conductive component of outer electrodes and inner electrodes and achieve a reduced ESR.

A multilayer ceramic capacitor according to an example embodiment of the present invention includes a multilayer body including a plurality of laminated dielectric layers, a first main surface and a second main surface opposite each other in a height direction, the height direction being a lamination direction of the dielectric layers, a first side surface and a second side surface opposite each other in a width direction perpendicular to the height direction, a first end surface and a second end surface opposite each other in a length direction perpendicular to the height direction and the width direction, first inner electrode layers alternately laminated with the plurality of dielectric layers and exposed at the first end surface, and second inner electrode layers alternately laminated with the plurality of dielectric layers and exposed at the second end surface, a first outer electrode on the first end surface, and a second outer electrode on the second end surface, wherein each of the first end surface and the second end surface is curved from the first main surface to the second main surface, and a radius of curvature of each of the first end surface and the second end surface is about 5/2 or less of a thickness of the multilayer body in the height direction at a central portion of the multilayer body in the length direction.

According to example embodiments of the present invention, it is possible to provide multilayer ceramic capacitors that achieve a high moisture resistance reliability, an improved bonding strength between a conductive component of outer electrodes and inner electrodes, and a reduced ESR, due to large exposed areas of the inner electrodes at end surfaces or the like because the end surfaces or the like of dielectric layers are curved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of the appearance of a multilayer ceramic capacitor that is an example of a multilayer ceramic capacitor according to a first example embodiment of the present invention.

FIG. 2 is a front view illustrating a multilayer ceramic capacitor that is an example of the multilayer ceramic capacitor according to the first example embodiment of the present invention.

FIG. 3 is a left side view illustrating a multilayer ceramic capacitor that is an example of the multilayer ceramic capacitor according to the first example embodiment of the present invention.

FIG. 4 is a sectional view taken along line IV-IV of FIG. 1.

FIG. 5 is a sectional view taken along line V-V of FIG. 1.

FIG. 6 is a schematic sectional view illustrating a structure around an end surface of the multilayer body of a multilayer ceramic capacitor that is an example of the multilayer ceramic capacitor according to the first example embodiment of the present invention.

FIG. 7 is a perspective view of an appearance of a multilayer ceramic capacitor that is an example of a multilayer ceramic capacitor according to a second example embodiment of the present invention.

FIG. 8 is a sectional view taken along line VIII-VIII of FIG. 7.

FIG. 9 is a sectional view taken along line IX-IX of FIG. 7.

FIG. 10 is a sectional view taken along line X-X of FIG. 7.

FIG. 11 is an exploded perspective view of the multilayer body illustrated in FIG. 7.

FIG. 12A is a schematic sectional view taken along line XIIa-XIIa of FIG. 10, and is a schematic sectional view for explaining the structure of a multilayer ceramic capacitor that is an example of a multilayer ceramic capacitor according to the second example embodiment of the present invention.

FIG. 12B is a schematic sectional view taken along line XIIb-XIIb of FIG. 10, and is a schematic sectional view for explaining the structure of a multilayer ceramic capacitor that is an example of a multilayer ceramic capacitor according to the second example embodiment of the present invention.

FIG. 12C is a schematic sectional view taken along line XIIc-XIIc of FIG. 10, and is a schematic sectional view for explaining the structure of a multilayer ceramic capacitor that is an example of a multilayer ceramic capacitor according to the second example embodiment of the present invention.

FIG. 12D is a schematic sectional view taken along line XIId-XIId of FIG. 10, and is a schematic sectional view for explaining the structure of a multilayer ceramic capacitor that is an example of a multilayer ceramic capacitor according to the second example embodiment of the present invention.

FIG. 13 is a schematic sectional view taken along line XIII-XIII of FIG. 10, and is a schematic sectional view for explaining the structure of a multilayer ceramic capacitor that is an example of a multilayer ceramic capacitor according to the second example embodiment of the present invention.

FIG. 14 is a sectional view illustrating a modification of line X-X of FIG. 7.

FIG. 15 is an exploded perspective view illustrating a variation of the multilayer body illustrated in FIG. 7.

FIG. 16A illustrates a schematic sectional view for explaining the structure of outer electrodes of a multilayer ceramic capacitor that is an example of a multilayer ceramic capacitor according to a variation of the second example embodiment of the present invention, and FIG. 16B a schematic sectional view for explaining the structure of outer electrodes different from those of the multilayer ceramic capacitor in FIG. 16A.

FIG. 17A illustrates a schematic sectional view for explaining the structure of outer electrodes of a multilayer ceramic capacitor that is an example of a multilayer ceramic capacitor according to another variation of the second example embodiment of the present invention, and FIG. 17B a schematic sectional view for explaining the structure of outer electrodes different from those of the multilayer ceramic capacitor in FIG. 17A.

FIG. 18A illustrates a schematic sectional view for explaining the structure of outer electrodes of a multilayer ceramic capacitor that is an example of a multilayer ceramic capacitor according to another variation of the second example embodiment of the present invention, and FIG. 18B a schematic sectional view for explaining the structure of outer electrodes different from those of the multilayer ceramic capacitor in FIG. 18A.

### DETAILED DESCRIPTION OF THE EXAMPLE EMBODIMENTS

### A. First Example Embodiment

### 1. Multilayer Ceramic Capacitor

A multilayer ceramic capacitor 10 that is an example of a multilayer ceramic capacitor according to a first example embodiment of the present invention will be described.

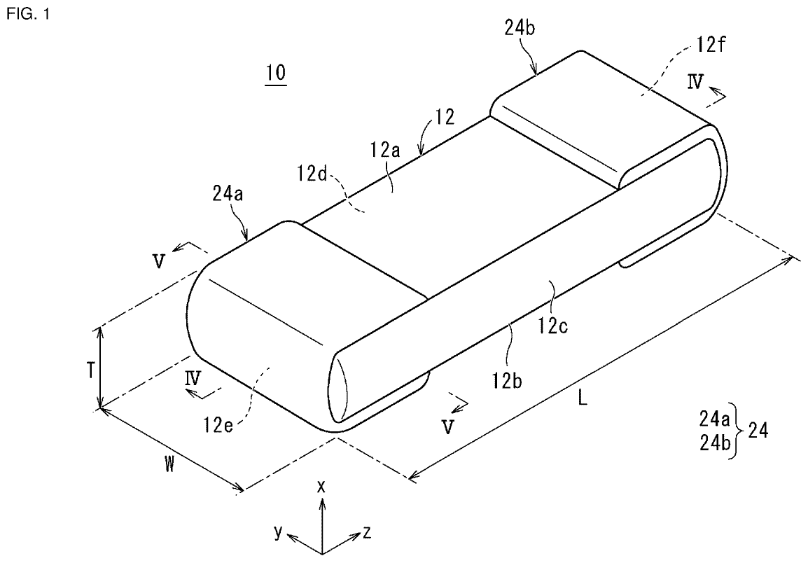

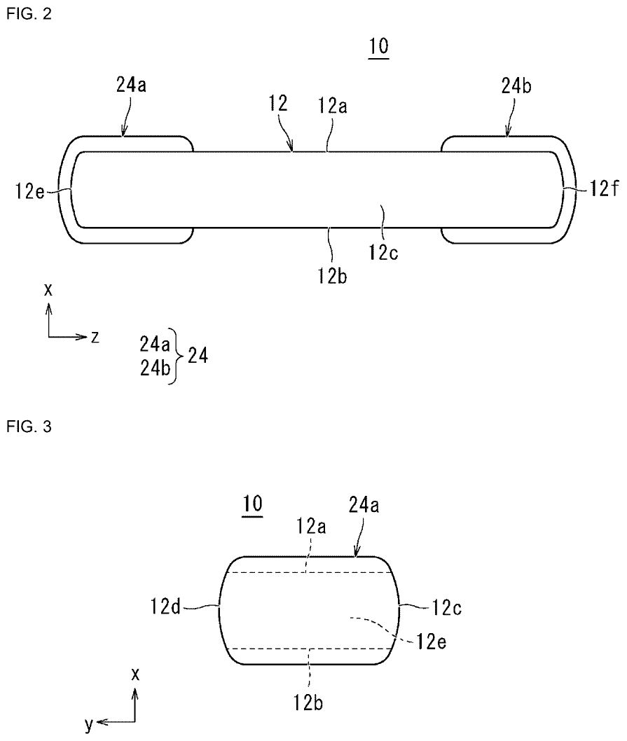

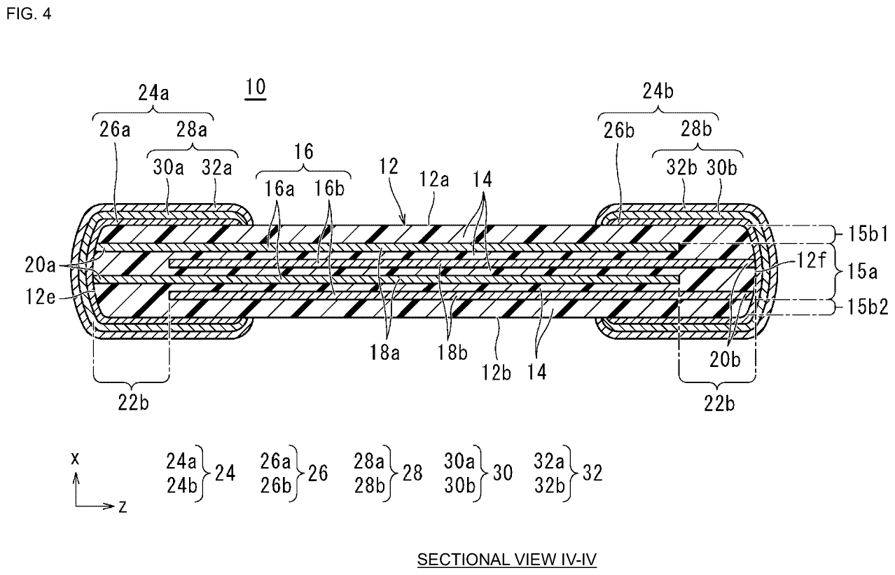

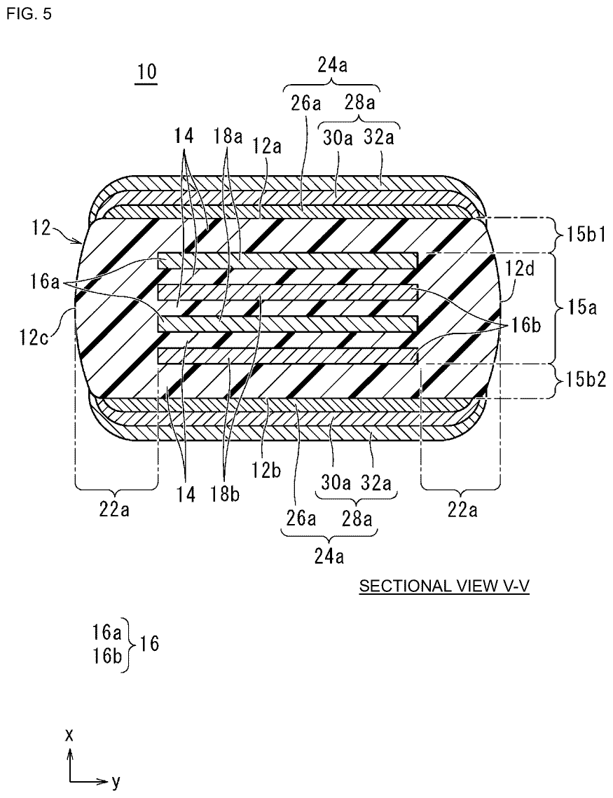

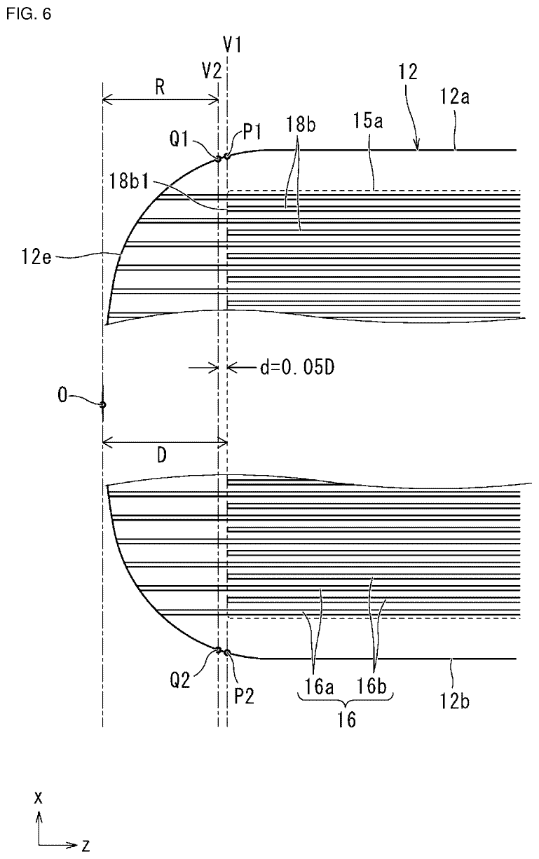

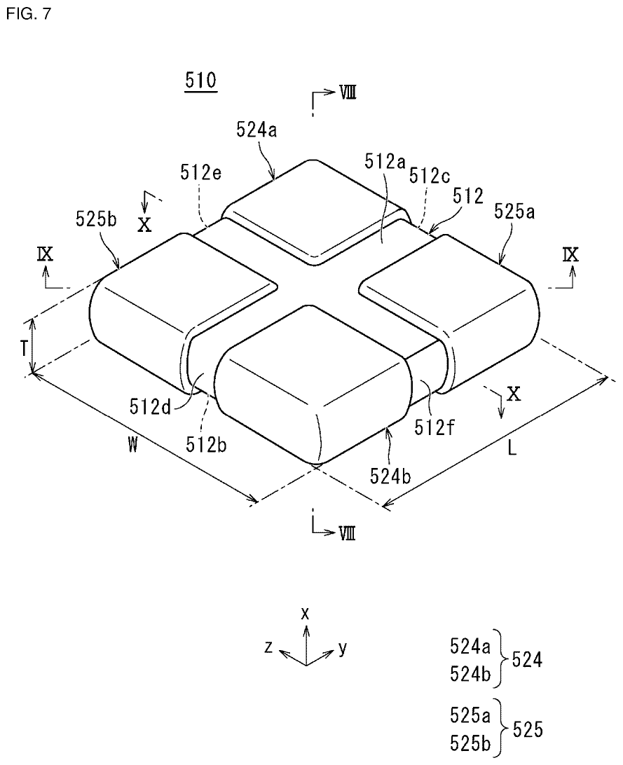

FIG. 1 is a perspective view of the appearance of the multilayer ceramic capacitor that is an example of the multilayer ceramic capacitor according to the first example embodiment of the present invention. FIG. 2 is a front view illustrating the multilayer ceramic capacitor that is an example of the multilayer ceramic capacitor according to the first example embodiment of the present invention. FIG. 3 is a left side view illustrating a multilayer ceramic capacitor that is an example of the multilayer ceramic capacitor according to the first example embodiment of the present invention. FIG. 4 is a sectional view taken along line IV-IV of FIG. 1. FIG. 5 is a sectional view taken along line V-V of FIG. 1. FIG. 6 is a schematic sectional view illustrating a structure around an end surface of the multilayer body of a multilayer ceramic capacitor that is an example of the multilayer ceramic capacitor according to the first example embodiment of the present invention.

The multilayer ceramic capacitor 10 includes a multilayer body 12 and outer electrodes 24. Each configuration will be described below in the order of the multilayer body 12 and the outer electrodes 24.

### Multilayer Body

The multilayer body 12 includes a plurality of dielectric layers 14 and a plurality of inner electrode layers 16, which are laminated. The multilayer body 12 includes a first main surface 12a and a second main surface 12b opposite each other in the height direction x, which is a lamination direction of the plurality of dielectric layers 14, a first side surface 12c and a second side surface 12d opposite each other in the width direction y perpendicular to the height direction x, and a first end surface 12e and a second end surface 12f opposite each other in the length direction z perpendicular to the height direction x and the width direction y. A corner portion refers to a portion where three adjacent surfaces of the multilayer body 12 intersect. A ridge portion refers to a portion where two adjacent surfaces of the multilayer body 12 intersect. Unevenness or the like may be provided in a portion of or all of the first main surface 12a and the second main surface 12b, the first side surface 12c and the second side surface 12d, and the first end surface 12e and the second end surface 12f.

As illustrated in FIGS. 4 and 5, the multilayer body 12 includes, in the height direction x connecting the first main surface 12a and the second main surface 12b, an effective layer portion 15a in which the plurality of inner electrode layers 16 are opposite each other, a first outer layer portion 15b1 including the plurality of dielectric layers 14 located between the first main surface 12a and the inner electrode layer 16 closest to the first main surface 12a, and a second outer layer portion 15b2 including the plurality of dielectric layers 14 located between the second main surface 12b and the inner electrode layer 16 closest to the second main surface 12b.

The first outer layer portion 15b1 is located adjacent to the first main surface 12a of the multilayer body 12 and is an assembly of the plurality of dielectric layers 14 located between the first main surface 12a and the inner electrode layer 16 closest to the first main surface 12a.

The second outer layer portion 15b2 is located adjacent to the second main surface 12b of the multilayer body 12 and is an assembly of the plurality of dielectric layers 14 located between the plurality of dielectric layers 14 located between the second main surface 12b and the inner electrode layer 16 closest to the second main surface 12b.

A region interposed between the first outer layer portion 15b1 and the second outer layer portion 15b2 is the effective layer portion 15a.

The number of the dielectric layers 14 laminated is not particularly limited, but is preferably 10 or more and 2,000 or less, including the first outer layer portion 15b1 and the second outer layer portion 15b2. The thickness of each of the dielectric layers 14 is preferably about 10 μm or less, for example.

The dielectric layers 14 can be made of, for example, a dielectric material. For example, a dielectric ceramic material including, for example, BaTiO₃, CaTiO₃, SrTiO₃, or CaZnO₃ as a main component can be used as the dielectric material. A material may be used in which a subcomponent, such as a Mn compound, an Fe compound, a Cr compound, a Co compound, or a Ni compound, is added to the main component.

The dielectric layers 14 can include a plurality of crystal grains including a perovskite-type compound based on BaTiO₃ as a basic structure.

Smaller thicknesses of the dielectric layers 14 result in greater capacitance of the capacitor; thus, a crystal grain size of, for example, about 1 μm or less is preferred. The size of the crystal grains is appropriately designed in accordance with the thicknesses of the dielectric layers 14.

In particular, the thickness of the first outer layer portion 15b1 is preferably about 1 μm or more and about 15 μm or less, for example. The thickness of the second outer layer portion 15b2 is preferably about 1 μm or more and about 15 μm or less, for example.

The thickness of the first outer layer portion 15b1 is defined by measuring the distance between the first main surface 12a and either the first inner electrode layer 16a or the second inner electrode layer 16b serving as the inner electrode layer 16 closest to the first main surface 12a.

The thickness of the second outer layer portion 15b2 is

defined by measuring the distance between the second main surface 12b and either the first inner electrode layer 16a or the second inner electrode layer 16b serving as the inner electrode layer 16 closest to the second main surface 12b.

The dimensions of the multilayer body 12 in the height direction x, width direction y, and length direction z are not particularly limited.

The first end surface 12e of the multilayer body 12 is preferably curved from the first main surface 12a to the second main surface 12b.

The second end surface 12f of the multilayer body 12 is preferably curved from the first main surface 12a to the second main surface 12b.

As a result, the inner electrode layers 16 have increased exposed areas on the first end surface 12e and the second end surface 12f, resulting in increased bonding strength between the conductive component of the outer electrodes 24 and the multilayer body 12. Furthermore, because of the increased exposed areas of the conductive component of the outer electrodes 24, an increase in ESR is inhibited.

The radius of curvature of the curved first end surface 12e is preferably about 5/2 or less of the thickness dimension of the multilayer body 12 in the height direction x at the central portion in the length direction z of the multilayer body 12, for example.

The radius of curvature of the curved second end surface 12f is preferably about 5/2 or less of the thickness dimension of the multilayer body 12 in the height direction x at the central portion in the length direction z of the multilayer body 12.

When the radius of curvature is about 5/2 or more, the exposed areas of the inner electrode layers 16 are reduced. Thus, the bonding areas between the conductive component in the outer electrodes 24 and the inner electrode layers 16 are reduced, reducing the bonding strength between the outer electrodes 24 and the multilayer body 12. In addition, it is difficult to sufficiently reduce ESR.

The radius of curvature of the first end surface 12e and the second end surface 12f of the multilayer body 12 can be measured by the following measurement method.

A section of the multilayer ceramic capacitor 10 is exposed. Specifically, the multilayer ceramic capacitor 10 is polished to a position corresponding to about 1/2 W in such a manner that the section is substantially parallel to the first side surface 12c or the second side surface 12d. The section is observed with a microscope (VHX 5000: manufactured by Keyence Corporation) at a magnification of 1,500×. The dimension in the height direction x connecting the first main surface 12a and the second main surface 12b in the polished section of the multilayer body 12 is measured.

As illustrated in FIG. 6, on the side of the first end surface 12e, a position where the dimension of the first end surface 12e in the length direction is the maximum is defined as a position O. Among the plurality of electrode layers of the inner electrode layers 16, a point of intersection of a perpendicular line (a straight line in the height direction x) V1 passing through the end portions 18b1 of the second counter electrode portions 18b of the second inner electrode layers 16b, which are not exposed at the first end surface 12e side, and the surface of the multilayer body 12 on the first main surface 12a side is defined as a position P1. A point of intersection of the perpendicular line V1 and the surface of the second main surface 12b side of the multilayer body 12 is defined as a position P2.

In the length direction z, the distance D between the position P1 and the position O is measured. A point of intersection of a perpendicular line V2 passing through a position shifted to the first end surface 12e side by a distance d, which is a dimension of, for example, about 5% of the distance D, from the position P1 and the surface of the multilayer body 12 on the first main surface 12a side is defined as a position Q1. A point of intersection of the perpendicular line V2 passing through a position shifted to the first end surface 12e side by a distance d from the position P2 and the surface of the multilayer body 12 on the second main surface 12b side is defined as a position Q2.

The radius of curvature of the contour portion R of the section passing through the position O with each of the positions Q1 and Q2 as starting points is measured, and this is defined as the radius of curvature of the first end surface 12e.

Although not illustrated in the drawings, on the side of the second end surface 12f, a position where the dimension of the second end surface 12f in the length direction z is the maximum is defined as a position O′. Among the plurality of electrode layers of the inner electrode layers 16, a position P1′, which is a point of intersection of a perpendicular line passing through the end portions of the second counter electrode portions 18a of the first inner electrode layers 16a, which are not exposed at the second end surface 12f side, and the surface of the multilayer body 12 on the first main surface 12a side, is measured. A position P2′, which is a point of intersection of the perpendicular line and the surface of the second main surface 12b side of the multilayer body 12, is measured.

In the length direction z, a point of intersection of a perpendicular line passing through a position shifted to the second end surface 12f side by a distance d′, which is a dimension of, for example, about 5% of a distance D between the position P1′ and the position O′, and the surface of the multilayer body 12 on the first main surface 12a side is defined as a position Q1′. A point of intersection of the perpendicular line passing through a position shifted to the second end surface 12f side by a distance d′ from the position P2′ and the surface of the multilayer body 12 on the second main surface 12b side is defined as a position Q2′.

The radius of curvature of the contour portion R′ of the section passing through the position O′ with each of the positions Q1′ and Q2′ as starting points is measured, and this is defined as the radius of curvature of the second end surface 12f.

With regard to the plurality of second inner electrode layers 16b, when the positions of the end portions of the second counter electrode portions 18b are not aligned in the length direction z, the position P1 and the position P2 are measured based on the position of the end portion 18b1 of the second inner electrode layer 16b closest to the first end surface 12e, which is indicated by the reference numeral. Then, the position Q1 and the position Q2, which are starting points of the measurement of the radius of curvature, are defined.

The thickness of the multilayer body 12 in the height direction x is preferably about 60 μm or less, for example. When the thickness is about 60 μm or less, the above-described effects of example embodiments of the present invention can be provided.

The first side surface 12c is preferably curved from the first main surface 12a to the second main surface 12b.

The second side surface 12d is preferably curved from the first main surface 12a to the second main surface 12b.

This inhibits the chipping and cracking of the multilayer body 12.

### Inner Electrode Layer

As illustrated in FIGS. 4 and 5, the inner electrode layers 16 includes the first inner electrode layers 16a and the second inner electrode layers 16b. The first inner electrode layers 16a and the second inner electrode layers 16b are alternately laminated with the dielectric layers 14 interposed therebetween.

The first inner electrode layers 16a are disposed on the surfaces of the dielectric layers 14. Each of the first inner electrode layers 16a includes a first counter electrode portion 18a opposite a corresponding one of the second inner electrode layers 16b, and a first extension electrode portion 20a located on one end side of a corresponding one of the first inner electrode layers 16a and extending from the first counter electrode portion 18a to the first end surface 12e of the multilayer body 12. An end portion of the first extension electrode portion 20a extends to and is exposed at the first end surface 12e.

The shape of the first counter electrode portion 18a of the first inner electrode layer 16a is preferably, but not particularly limited to, rectangular in plan view. The corner portions may be rounded in plan view, or the corner portions may be formed obliquely (tapered) in plan view. The corner portions may be tapered so as to be inclined toward either side in plan view.

The shape of the first extension electrode portion 20a of the first inner electrode layer 16a is preferably, but not particularly limited to, rectangular in plan view. The corner portions may be rounded in plan view, or the corner portions may be formed obliquely (tapered) in plan view. The corner portions may be tapered so as to be inclined toward either side in plan view.

The width of the first counter electrode portion 18a of the first inner electrode layer 16a and the width of the first extension electrode portion 20a of the first inner electrode layer 16a may be the same. Either one may have a narrower width.

Each of the second inner electrode layers 16b is disposed on a surface of a corresponding one of the dielectric layers 14 different from the dielectric layers 14 on which the first inner electrode layers 16a are disposed. The second inner electrode layer 16b includes the second counter electrode portion 18b opposite the first inner electrode layer 16a and a second extension electrode portion 20b located on one end side of the second inner electrode layer 16b and extending from the second counter electrode portion 18b to the second end surface 12f of the multilayer body 12. An end portion of the second extension electrode portion 20b extends to and is exposed at the second end surface 12f.

The shape of the second counter electrode portion 18b of the second inner electrode layer 16b is preferably, but not particularly limited to, a rectangular shape in plan view. The corner portions may be rounded in plan view, or the corner portions may be formed obliquely (tapered) in plan view. The corner portions may be tapered so as to be inclined toward either side in plan view.

The shape of the second extension electrode portion 20b of the second inner electrode layer 16b is preferably, but not particularly limited to, rectangular in plan view. The corner portions may be rounded in plan view, or the corner portions may be formed obliquely (tapered) in plan view. The corner portions may be tapered so as to be inclined toward either side in plan view.

The width of the second counter electrode portion 18b of the second inner electrode layer 16b and the width of the second extension electrode portion 20b of the second inner electrode layer 16b may be the same. Either one may have a narrower width.

The first extension electrode portion 20a of the first inner electrode layer 16a may be curved toward the center of the first end surface 12e of the multilayer body 12.

The second extension electrode portion 20b of the second inner electrode layer 16b may be curved toward the center of the second end surface 12f of the multilayer body 12.

Of the first extension electrode portions 20a, extending to the first end surface 12e, of the first inner electrode layers 16a, the distance between the portion located closest to the first main surface 12a and the portion located closest to the second main surface 12b may be smaller than the distance between the portion located closest to the first main surface 12a and the portion located closest to the second main surface 12b, of the first counter electrode portions 18a of the first inner electrode layers 16a.

Of the second extension electrode portions 20b, extending to the second end surface 12f, of the second inner electrode layers 16b, the distance between the portion located closest to the first main surface 12a and the portion located closest to the second main surface 12b may be smaller than the distance between the portion located closest to the first main surface 12a and the portion located closest to the second main surface 12b, of the second counter electrode portions 18b of the second inner electrode layers 16b.

As illustrated in FIG. 4, the multilayer body 12 includes end portions (hereinafter, referred to as “L gaps”) 22b of the multilayer body 12 disposed between the end portion of the first inner electrode layer 16a opposite to the first extension electrode portion 20a and the second end surface 12f and between the end portion of the second inner electrode layer 16b opposite to the second extension electrode portion 20b and the first end surface 12e.

As illustrated in FIG. 5, the multilayer body 12 includes side portions (hereinafter, referred to as “W gaps”) 22a of the multilayer body 12 disposed between one end of each of the first counter electrode portion 18a and the second counter electrode portion 18b in the width direction y and the first side surface 12c and between the other end of each of the first counter electrode portion 18a and the second counter electrode portion 18b in the width direction y and the second side surface 12d.

A step layer may be disposed in each of the L gaps 22b.

The first inner electrode layer 16a or the second inner electrode layer 16b may be arranged so as to cover a portion of the step layer, or the step layer may be arranged so as to cover a portion of the first inner electrode layer 16a or the second inner electrode layer 16b.

The step layer preferably has the same thickness as the dielectric layer 14.

The step layer has components that are preferably, but not limited to, the same as those of the dielectric layer 14.

A first dummy electrode layer and a second dummy electrode layer may be disposed in the L gap 22b.

The first dummy electrode layer and the second dummy electrode layer may be disposed in the first outer layer portion 15b1 and the second outer layer portion 15b2. In this case, the dummy layers are preferably disposed on portions corresponding to the locations where the L gaps 22b are subjected to translation in the height direction x.

The first dummy electrode layer preferably has a thickness equal or substantially equal to the total thickness of the first inner electrode layers 16a. That is, the first dummy electrode layer preferably has a thickness equal or substantially equal to the thickness of each first inner electrode layer 16a× the number of the first inner electrode layers 16a.

The first inner electrode layer 16a and the second inner electrode layer 16b can be made of an appropriate conductive material, such as a metal, e.g., Ni, Cu, Ag, Pd, or Au, or an alloy, e.g., an Ag-Pd alloy, including at least one of these metals. In the present example embodiment, the first counter electrode portion 18a of the first inner electrode layer 16a and the second counter electrode portion 18b of the second inner electrode layer 16b are opposite each other with the dielectric layer 14 interposed therebetween, thus generating an electrostatic capacitance to exhibit the characteristics of a capacitor.

To increase the capacitance of the capacitor, it is preferable to increase the area of each of the first inner electrode layer 16a and the second inner electrode layer 16b of the inner electrode layers 16. Thus, the LW plane coverage of each of the first inner electrode layer 16a and the second inner electrode layer 16b is preferably about 90% or more, for example. The LW plane coverage is defined as a ratio obtained by subtracting the area of a gap from the area inside the edge portion of the first inner electrode layer 16a or the second inner electrode layer 16b when viewed from the LW plane (the plane formed by the length direction z and the width direction y) of the multilayer body 12.

When the LW plane coverage is high, the capacitance of the capacitor is high. However, even if the LW plane coverage is low, the dielectric layers 14 are bonded to each other at the gap to increase the bonding strength between the layers. Thus, delamination is less likely to occur.

The thickness of each of the first inner electrode layer 16a and the second inner electrode layer 16b is preferably uniform. However, the thickness of the edge portion thereof in the width direction y may be larger than the thickness of the central portion thereof in the width direction y.

The thickness of the first inner electrode layer 16a and the second inner electrode layer 16b is preferably, for example, about 0.2 μm or more and about 2.0 μm or less.

The total number of the first inner electrode layers 16a and the second inner electrode layers 16b is preferably 10 or more and 2,000 or less, for example.

### Outer Electrode

As illustrated in FIGS. 1 to 4, the outer electrodes 24 are disposed on the first end surface 12e side and the second end surface 12f side of the multilayer body 12.

The outer electrodes 24 include underlying electrode layers 26 and plating layers 28 disposed so as to cover the underlying electrode layers 26.

The outer electrodes 24 include a first outer electrode 24a and a second outer electrode 24b.

The first outer electrode 24a is disposed only on the surface of the first end surface 12e, a portion of the first main surface 12a, and a portion of the second main surface 12b of the multilayer body 12. In this case, the first outer electrode 24a is electrically connected to the first extension electrode portions 20a of the first inner electrode layers 16a. Although the first outer electrode 24a is not disposed on a portion of the first side surface 12c or a portion of the second side surface 12d, the first outer electrode 24a may extend thereto to some extent.

The second outer electrode 24b is disposed only on the surface of the second end surface 12f, a portion of the first main surface 12a, and a portion of the second main surface 12b of the multilayer body 12. In this case, the second outer electrode 24b is electrically connected to the second extension electrode portions 20b of the second inner electrode layers 16b. Although the second outer electrode 24b is not disposed on a portion of the first side surface 12c or a portion of the second side surface 12d, the second outer electrode 24b may extend thereto to some extent.

The thickness of each of the first outer electrode 24a and the second outer electrode 24b is preferably, for example, about 1 μm or more and about 30.0 μm or less.

### Underlying Electrode Layer

The underlying electrode layers 26 include a first underlying electrode layer 26a and a second underlying electrode layer 26b.

The first underlying electrode layer 26a is disposed so as to cover the first end surface 12e of the multilayer body 12, a portion of the first main surface 12a on the first end surface 12e side of the multilayer body 12, and a portion of the second main surface 12b on the first end surface 12e side of the multilayer body 12.

The second underlying electrode layer 26b is disposed so as to cover the second end surface 12f of the multilayer body 12, a portion of the first main surface 12a on the second end surface 12f side of the multilayer body 12, and a portion of the second main surface 12b on the second end surface 12f side of the multilayer body 12.

Each underlying electrode layer 26 formed of a thin film layer includes at least one selected from a baked layer, a conductive resin layer, or a thin film layer, and the like.

### For Baked Layer

The baked layer includes a glass component and a metal component. The glass component of the baked layer includes at least one selected from B, Si, Ba, Mg, Al, or Li, and the like. The metal component of the baked layer includes, for example, at least one selected from Cu, Ni, Ag, Pd, an Ag-Pd alloy, or Au, and the like. The baked layer is formed by applying a conductive paste including the glass component and the metal component to the multilayer body 12 and then baking the paste.

The baked layer may be formed by simultaneously firing a multilayer chip including the inner electrode layers 16 and the dielectric layers 14 and the conductive paste applied to the multilayer chip, or may be formed by firing a multilayer chip including the inner electrode layers 16 and the dielectric layers 14 to produce a multilayer body and then baking the conductive paste to the multilayer body.

When the multilayer chip including the inner electrode layers 16 and the dielectric layers 14 and the conductive paste applied to the multilayer chip are simultaneously fired, the baked layer is preferably formed by baking a material to which a dielectric material is added in place of the glass component.

The baked layer may include a plurality of layers.

In the case of the baked layer, the thickness of the first underlying electrode layer 26a located on the first end surface 12e at the central portion in the height direction x is preferably, for example, about 0.1 μm or more and about 200 μm or less. The thickness of the second underlying electrode layer 26b located on the second end surface 12f at the central portion in the height direction x is preferably, for example, about 0.1 μm or more and about 200 μm or less.

When the first underlying electrode layer 26a as a baked layer is disposed on the first main surface 12a and the second main surface 12b, the thickness of the first underlying electrode layer 26a located on the first main surface 12a and the second main surface 12b at the central portion in the height direction x is preferably, for example, about 0.1 μm or more and about 200 μm or less.

When the second underlying electrode layer 26b as a baked layer is disposed on the first main surface 12a and the second main surface 12b, the thickness of the second underlying electrode layer 26b located on the first main surface 12a and the second main surface 12b at the central portion in the height direction x is preferably, for example, about 0.1 μm or more and about 200 μm or less.

### For Conductive Resin Layer

The underlying electrode layer 26 as a conductive resin layer includes a thermosetting resin and a metal. The conductive resin layer includes a thermosetting resin and thus is more flexible than, for example, a conductive layer formed of a plating film or a baked product of a conductive paste. Therefore, even if the multilayer ceramic capacitor is subjected to a physical shock or a shock caused by a thermal cycle, the conductive resin layer functions as a buffer layer, making it possible to inhibit the multilayer ceramic capacitor from cracking.

As the metal included in the conductive resin layer, Ag, Cu, Ni, or an alloy thereof can be used. A metal powder with a Ag-coated surface can be used. In the case of using the metal powder with a Ag-coated surface, it is preferable to use Cu or Ni as the metal powder. Furthermore, Cu that has been subjected to anti-oxidation treatment can also be used.

The reasons why the conductive metal powder of Ag is used as the metal included in the conductive resin layer are that Ag is suitable as an electrode material because Ag has the lowest resistivity among metals and that since Ag is a noble metal, Ag does not oxidize and has high oxidation resistance. The reason why the metal coated with Ag is used is that an inexpensive metal can be used as a base metal while the above-described characteristics of Ag are maintained.

The amount of metal included in the conductive resin layer is preferably, for example, about 35 vol % or more and about 75 vol % or less based on the total volume of the conductive resin.

The average particle diameter of the metal included in the conductive resin layer is not particularly limited. The average particle diameter of the conductive filler may be, for example, about 0.3 μm or more and about 10 μm or less.

The metal included in the conductive resin layer is mainly responsible for the conductivity of the conductive resin layer. Specifically, the conductive filler particles are brought into contact with each other to form a conductive path inside the conductive resin layer.

The metal included in the conductive resin layer is not particularly limited, but spherical or flat metals can be used. A mixture of a spherical metal powder and a flat metal powder is preferably used.

As a resin of the conductive resin layer, various known thermosetting resins, such as epoxy resins, phenolic resins, urethane resins, silicone resins, or polyimide resins, can be used. Among these, an epoxy resin having excellent heat resistance, moisture resistance, and adhesion is one of the most suitable resins.

The amount of resin included in the conductive resin layer is preferably, for example, about 25 vol % or more and about 65 vol % or less based on the total volume of the conductive resin. The conductive resin layer preferably includes a

thermosetting resin and a curing agent. When an epoxy resin is used as a base resin, various known compounds, such as phenolic, amine-based, acid anhydride-based, and imidazole-based compounds, can be used as the curing agent for the epoxy resin.

The underlying electrode layer 26 as the conductive resin layer may include a plurality of layers. The conductive resin layer may be disposed on the baked layer so as to cover the baked layer or may be disposed directly on the multilayer body.

In the case of the conductive resin layer, the thickness of the first underlying electrode layer 26a located on the first end surface 12e at the central portion in the height direction x is preferably, for example, about 10 μm or more and about 200 μm or less. The thickness of the second underlying electrode layer 26b located on the second end surface 12f at the central portion in the height direction x is preferably, for example, about 10 μm or more and about 200 μm or less.

When the first underlying electrode layer 26a as the conductive resin layer is disposed on the first main surface 12a and the second main surface 12b, the thickness of the first underlying electrode layer 26a located on the first main surface 12a and the second main surface 12b at the central portion in the height direction x is preferably, for example, about 5 μm or more and about 50 μm or less.

When the second underlying electrode layer 26b as the conductive resin layer is disposed on the first main surface 12a and the second main surface 12b, the thickness of the second underlying electrode layer 26b located on the first main surface 12a and the second main surface 12b at the central portion in the height direction x is preferably, for example, about 5 μm or more and about 50 μm or less.

### For Thin Film Layer

Each underlying electrode layer 26 as the thin film layer is preferably formed by a thin film formation method such as a sputtering method or a vapor deposition method. The thin film layer is preferably a layer having deposited metal particles and having a thickness of about 1 μm or less, for example.

### Plating Layer

The plating layers 28 include a first plating layer 28a and a second plating layer 28b.

The first plating layer 28a is disposed so as to cover the first underlying electrode layer 26a.

The second plating layer 28b is disposed so as to cover the second underlying electrode layer 26b.

The plating layers 28 include a plurality of layers.

Each plating layer 28 preferably includes, for example, at least one selected from Cu, Ni, Ag, Pd, an Ag-Pd alloy, or Au, and so forth.

The plating layers 28 may include a plurality of layers. In the present example embodiment, each plating layer 28 has a two-layer structure of a Ni plating layer and a Sn plating layer. The plating layers 28 include lower plating layers 30 that are Ni plating layers covering the underlying electrode layers 26 and upper plating layers 32 that are Sn plating layers arranged so as to cover the lower plating layers 30.

Each lower plating layer 30 has a first lower plating layer 30a and a second lower plating layer 30b.

The first lower plating layer 30a is disposed so as to cover a surface of the first underlying electrode layer 26a. Specifically, the first lower plating layer 30a is disposed over the first end surface 12e on a surface of the first underlying electrode layer 26a and extends to the first main surface 12a and the second main surface 12b on the surface of the first underlying electrode layer 26a.

The second lower plating layer 30b is disposed so as to cover a surface of the second underlying electrode layer 26b. Specifically, the second lower plating layer 30b is disposed over the second end surface 12f on a surface of the second underlying electrode layer 26b and extends to the first main surface 12a and the second main surface 12b on the surface of the second underlying electrode layer 26b.

The upper plating layers 32 include a first upper plating layer 32a and a second upper plating layer 32b.

The first upper plating layer 32a is disposed so as to cover the first lower plating layer 30a. Specifically, the first upper plating layer 32a is disposed over the first end surface 12e on a surface of the first lower plating layer 30a and extends to the first main surface 12a and the second main surface 12b on the surface of the first lower plating layer 30a.

The second upper plating layer 32b is disposed so as to cover the second lower plating layer 30b. Specifically, the second upper plating layer 32b is disposed over the second end surface 12f on a surface of the second lower plating layer 30b and extends to the first main surface 12a and the second main surface 12b on the surface of the second lower plating layer 30b.

When each plating layer 28 has a three-layer structure, a Sn plating layer, a Ni plating, and a Sn plating layer are preferably laminated in this order.

The plating layers preferably have a thickness per layer of, for example, about 1 μm or more and about 15 μm or less.

### For Direct Plating Layer

The plating layers may be direct plating layers formed directly on the surface of the multilayer body 12. That is, the multilayer ceramic capacitor 10 may have a structure including each direct plating layer electrically connected to the first inner electrode layers 16a or the second inner electrode layer 16b. In this case, the direct plating layers may be formed after a catalyst is disposed on the surfaces of the multilayer body 12 as a pretreatment.

Each direct plating layer preferably includes, for example, at least one metal selected from Cu, Ni, Sn, Pb, Au, Ag, Pd, Bi, or Zn, and so forth, or an alloy including such a metal.

For example, when the first inner electrode layers 16a and the second inner electrode layers 16b include Ni, the direct plating layers preferably include Cu, which has good bonding properties with Ni.

The direct plating layers preferably have a thickness per layer of, for example, about 1 μm or more and about 15 μm or less.

Preferably, each plating layer is free of glass. The proportion of the metal per unit volume of the plating layer is preferably about 99% by volume or more, for example.

The dimension of the multilayer ceramic capacitor 10, including the multilayer body 12, the first outer electrode 24a, and the second outer electrode 24b, in the length direction z is defined as dimension L. The dimension of the multilayer ceramic capacitor 10, including the multilayer body 12, the first outer electrode 24a, and the second outer electrode 24b, in the height direction x is defined as dimension T. The dimension of the multilayer ceramic capacitor 10, including the multilayer body 12, the first outer electrode 24a, and the second outer electrode 24b, in the width direction y is defined as dimension W.

Regarding the dimensions of the multilayer ceramic capacitor 10, the dimension L in the length direction z is preferably about 0.2 mm or more and about 6.5 mm or less, the dimension T in the height direction x is preferably about 0.03 mm or more and about 6.5 mm or less, and the dimension W in the width direction y is preferably about 0.1 mm or more and about 5.5 mm or less, for example. The ESL can be reduced by reversing the dimension L and the dimension W to shorten the current path.

In the multilayer ceramic capacitor 10 illustrated in FIG. 1, each of the first end surface 12e and the second end surface 12f of the multilayer body 12 is curved from the first main surface 12a to the second main surface 12b, and the radius of curvature thereof is about 5/2 or less of the thickness dimension of the multilayer body 12 in the height direction x at the central portion in the length direction z of the multilayer body 12.

As a result, the inner electrode layers 16 can have increased exposed areas on the first end surface 12e and the second end surface 12f, resulting in increased bonding strength between the conductive component of the outer electrodes 24 and the multilayer body 12. Furthermore, because of the increased exposed area of the conductive component of the outer electrodes 24, ESR can be controlled at a low level.

In the multilayer ceramic capacitor 10 illustrated in FIG. 1, when each of the first side surface 12c and the second side surface 12d of the multilayer body 12 is curved from the first main surface 12a to the second main surface 12b, chipping and cracking of the multilayer body 12 can be inhibited.

### 2. Method for Manufacturing Multilayer Ceramic Capacitor

A non-limiting example of a method for manufacturing a multilayer ceramic capacitor of an example of a multilayer ceramic capacitor according to the first example embodiment will be described below.

Dielectric sheets and a conductive paste for inner electrodes are prepared. The dielectric sheets and the conductive paste for inner electrode layers include a binder (for example, a known organic binder) and a solvent (for example, a known organic solvent).

The conductive paste for inner electrodes is applied to the dielectric sheets in predetermined patterns by printing, such as screen printing or gravure printing, to form inner electrode patterns. Specifically, conductive paste layers are formed by applying a paste made of a conductive material to the dielectric sheets by the above-described printing method or the like. The paste made of the conductive material is, for example, a paste in which an organic binder and an organic solvent are added to a metal powder. With regard to the dielectric sheets, dielectric sheets for outer layers on which none of the inner electrode patterns are formed by printing are also prepared.

A stacked sheet is produced using the dielectric sheets on which the inner electrode patterns have been formed. That is, a predetermined number of the dielectric sheets for the outer layers on which none of the inner electrode patterns are formed are stacked. The dielectric sheets on which the inner electrode pattern corresponding to the first inner electrode layers 16a has been formed and the dielectric sheets on which the inner electrode pattern corresponding to the second inner electrode layers 16b has been formed are alternately stacked thereon. Furthermore, a predetermined number of the dielectric sheets for the outer layers on which none of the inner electrode patterns are formed are stacked thereon. Thus, a stacked sheet is formed.

The stacked sheet is pressed in the lamination direction by, for example, an isostatic press, to produce a laminated block.

The laminated block is cut into laminated chips with a predetermined size.

Barrel polishing is then performed to form laminated chips having a desired shape.

Specifically, the diameter of the media in barrel polishing is preferably, for example, about 0.2 mm or more and about 0.7 mm or less. The amount of the media is preferably, for example, about 200 cc or more and about 700 cc or less. The rotation is performed not only in one direction but also in multiple directions. In this way, barrel polishing is performed until the all end surfaces of the laminated chips have a desired rounded shape.

The laminated chips are fired to produce the multilayer bodies 12. The firing temperature depends on the materials of the dielectric layers and the inner electrode layers, but is preferably about 900° C. or higher and about 1, 400° C. or lower.

The underlying electrode layers 26 are formed on the first end surface 12e, the second end surface 12f, a portion of the first main surface 12a, and a portion of the second main surface 12b of the multilayer body 12.

### Case Where Underlying Electrode Layers Are Baked Layers

A conductive paste to be formed into underlying electrode layers is applied to the first end surface 12e, the second end surface 12f, a portion of the first main surface 12a, and a portion of the second main surface 12b of the multilayer body 12 to form the first underlying electrode layer 26a and the second underlying electrode layer 26b included in the underlying electrode layers 26.

In the case of forming the baked layers, a conductive paste including a glass component and a metal is applied by a method, such as dipping, and then subjected to baking treatment. In this case, the baking treatment temperature is preferably, for example, about 700° C. or higher and about 900° C. or lower. In the case of simultaneously firing the laminated chip including the inner electrode layers 16 and the dielectric layers 14 and the conductive paste applied to the laminated chip, the baked layers are preferably formed by firing a material to which a dielectric material is added in place of the glass component.

If necessary, the surfaces of the baked layers are subjected to plating.

### Case Where Underlying Electrode Layers Are Conductive Resin Layers

When the underlying electrode layers are formed of conductive resin layers, the following method is used. The conductive resin layers may be formed on the surfaces of the baked layers, or the conductive resin layers alone may be formed directly on the multilayer body without forming the baked layers.

With regard to a method for forming conductive resin layers, a conductive resin paste including a thermosetting resin and a metal component is applied to baked layers or the multilayer body, and heat treatment is performed at a temperature of, for example, about 250° C. or higher and about 550° C. or lower to thermally cure the resin, thus forming the conductive resin layers. The atmosphere during the heat treatment is preferably a N₂ atmosphere. To inhibit the scattering of the resin and the oxidation of various metal components, the oxygen concentration is preferably controlled to about 100 ppm or less, for example.

### Case Where Underlying Electrode Layers Are Thin Film Layers

When the underlying electrode layers are formed of thin film layers, a thin film formation method, such as a sputtering method or a vapor deposition method, is used. The underlying electrode layers 26 formed of thin film layers are layers having deposited metal particles and having a thickness of about 1 μm or less, for example.

### For Direct Plating Layer

Direct plating layers may be disposed on the exposed portions of the inner electrode layers 16 of the multilayer body 12. In this case, the following method is used.

The first end surface 12e, the second end surface 12f, a portion of the first main surface 12a, and a portion of the second main surface 12b of the multilayer body 12 of the multilayer body are subjected to plating treatment to form plating films directly on the exposed portions of the inner electrode layers 16.

In the plating treatment, either electrolytic plating or electroless plating may be used. Electroless plating has the disadvantage that pretreatment with a catalyst or the like is required to improve the plating deposition speed, making the process complicated. Therefore, it is usually preferable to use electrolytic plating. As a plating method, barrel plating is preferably used. If necessary, upper plating electrodes to be formed on the surfaces of the lower plating electrodes may be formed in the same manner.

The plating layers 28 are formed on the surfaces of the underlying electrode layers 26. In the present example embodiment, the lower plating layers 30, which are Ni plating layers, and the upper plating layers 32, which are Sn plating layers, arranged so as to cover the lower plating layers 30, are formed on the underlying electrode layers 26 as baked layers. The Ni plating layers and the Sn plating layers are sequentially formed by, for example, a barrel plating method.

In this way, the multilayer ceramic capacitor 10 illustrated in FIG. 1 can be manufactured.

In the non-limiting example of a method for manufacturing the multilayer ceramic capacitor according to the present example embodiment as described above, it is possible to manufacture the high-quality multilayer ceramic capacitor according to the present invention, the multilayer ceramic capacitor having high moisture resistance reliability, improved bonding strength between the conductive component of the outer electrodes and the inner electrodes, and a reduced ESR.

### B. Second Example Embodiment

### 1. Multilayer Ceramic Capacitor

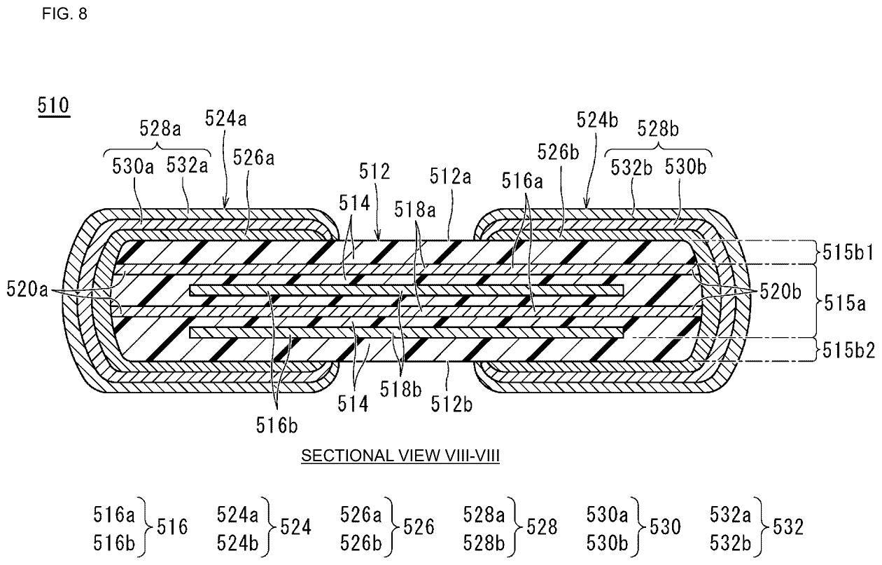

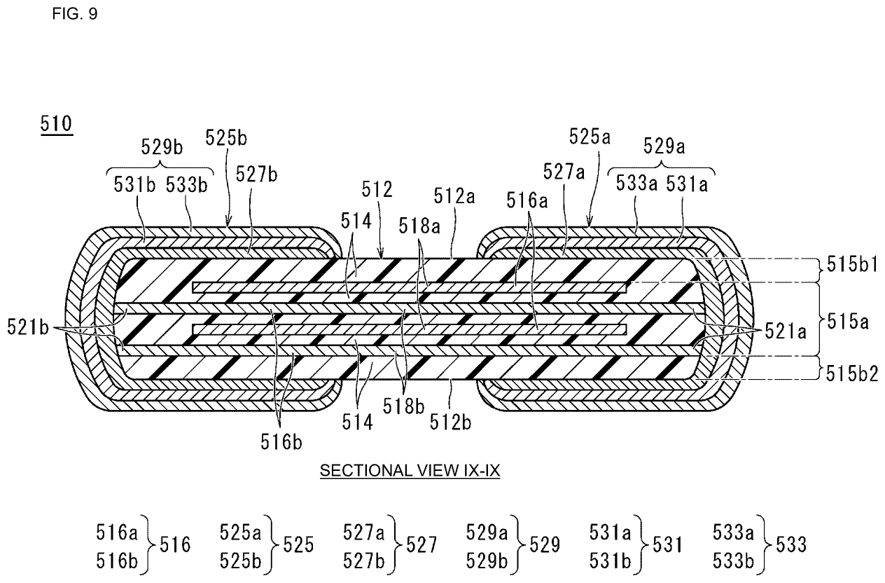

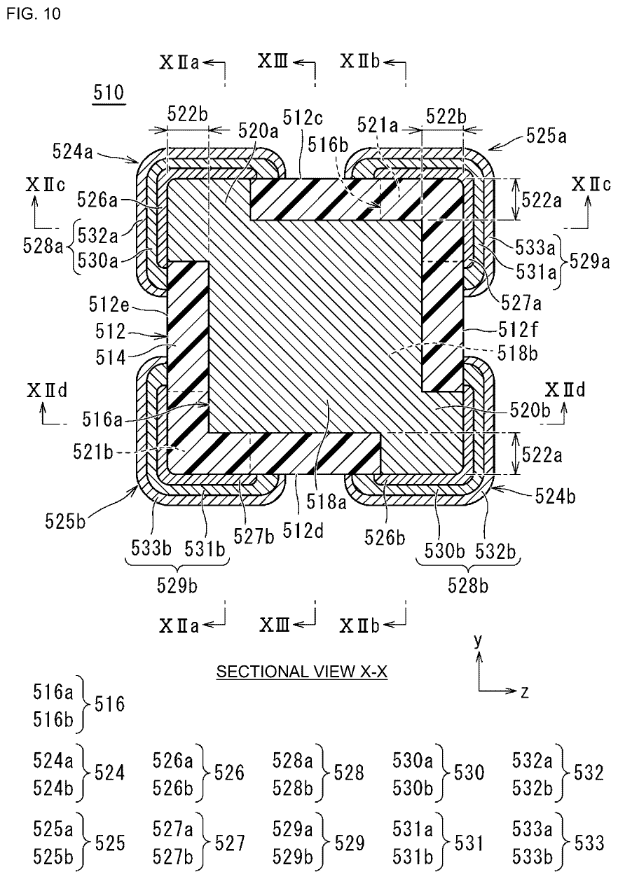

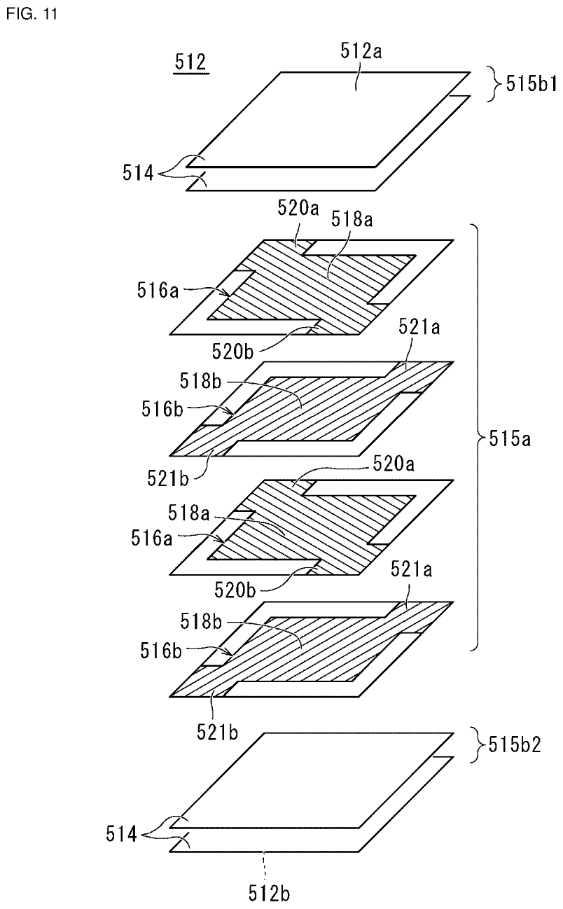

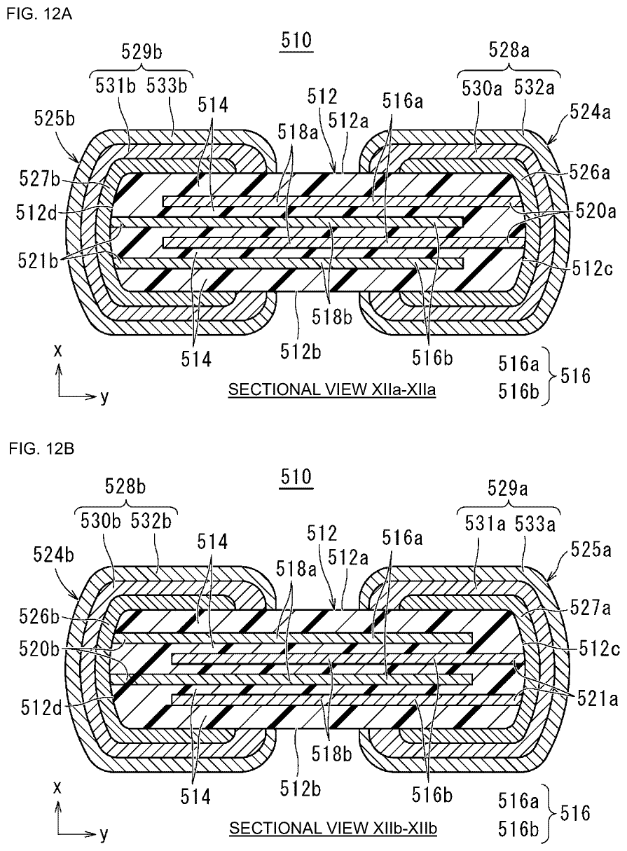

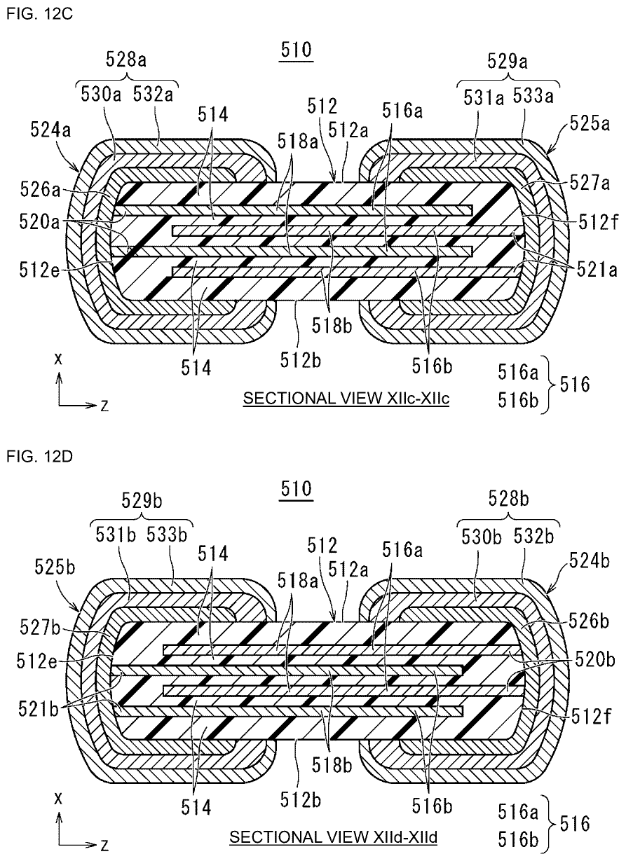

A multilayer ceramic capacitor according to a second example embodiment of the present invention will be described below. FIG. 7 is a perspective view of an appearance of a multilayer ceramic capacitor that is an example of a multilayer ceramic capacitor according to a second example embodiment of the present invention. FIG. 8 is a sectional view taken along line VIII-VIII of FIG. 7. FIG. 9 is a sectional view taken along line IX-IX of FIG. 7. FIG. 10 is a sectional view taken along line X-X of FIG. 7. FIG. 11 is an exploded perspective view of the multilayer body illustrated in FIG. 7. FIG. 12A is a schematic sectional view taken along line XIIa-XIIa of FIG. 10, and is a schematic sectional view for explaining the structure of a multilayer ceramic capacitor that is an example of the multilayer ceramic capacitor according to the second example embodiment of the present invention.

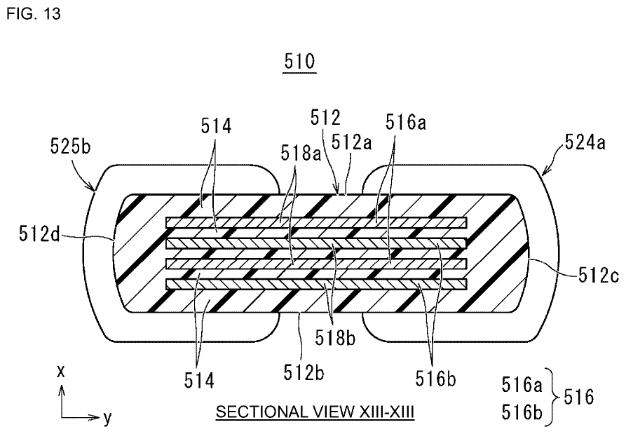

FIG. 12B is a schematic sectional view taken along line XIIb-XIIb of FIG. 10, and is a schematic sectional view for explaining the structure of a multilayer ceramic capacitor that is an example of the multilayer ceramic capacitor according to the second example embodiment of the present invention. FIG. 12C is a schematic sectional view taken along line XIIc-XIIc of FIG. 10, and is a schematic sectional view for explaining the structure of a multilayer ceramic capacitor that is an example of the multilayer ceramic capacitor according to the second example embodiment of the present invention. FIG. 12D is a schematic sectional view taken along line XIId-XIId of FIG. 10, and is a schematic sectional view for explaining the structure of the outer electrodes of a multilayer ceramic capacitor that is an example of the multilayer ceramic capacitor according to the second example embodiment of the present invention. FIG. 13 is a schematic sectional view taken along line XIII-XIII of FIG. 10, and is a schematic sectional view for explaining the structure of a multilayer ceramic capacitor that is an example of the multilayer ceramic capacitor according to the second example embodiment of the present invention.

A multilayer ceramic capacitor 510 includes a multilayer body 512 and outer electrodes 524 and 525.

### Multilayer Body

The multilayer body 512 includes a plurality of dielectric layers 514 and a plurality of inner electrode layers 516. The multilayer body 512 includes a first main surface 512a and a second main surface 512b opposite each other in the height direction x, a first side surface 512c and a second side surface 512d opposite each other in the width direction y perpendicular to the height direction x, and a third side surface 512e and a fourth side surface 512f opposite each other in the length direction z perpendicular to the height direction x and the width direction y. Each of the first main surface 512a and the second main surface 512b extends in the width direction y and the length direction z. Each of the first side surface 512c and the second side surface 512d extends in the height direction x and the width direction z. Each of the third side surface 512e and the fourth side surface 512f extends in the height direction x and the width direction y. Therefore, the height direction x is a direction connecting the first main surface 512a and the second main surface 512b. The width direction y is a direction connecting the first side surface 512c and the second side surface 512d. The length direction z is a direction connecting the third side surface 512e and the fourth side surface 512f.

The multilayer body 512 has a rectangular parallelepiped shape. A corner portion refers to a portion where three surfaces of the multilayer body 512 intersect. A ridge portion refers to a portion where two surfaces of the multilayer body 512 intersect.

As illustrated in FIGS. 8 and 9, the multilayer body 512 includes, in the height direction x connecting the first main surface 512a and the second main surface 512b, an effective layer portion 515a in which the plurality of inner electrode layers 516 are opposite each other, a first outer layer portion 515b1 including the plurality of dielectric layers 514 located between the first main surface 512a and the inner electrode layer 516 closest to the first main surface 512a, and a second outer layer portion 515b2 including the plurality of dielectric layers 514 located between the second main surface 512b and the inner electrode layer 516 closest to the second main surface 512b.

The first outer layer portion 515b1 is located adjacent to the first main surface 512a of the multilayer body 512 and is an assembly of the plurality of dielectric layers 514 located between the first main surface 512a and the inner electrode layer 516 closest to the first main surface 512a.

The second outer layer portion 515b2 is located adjacent to the second main surface 512b of the multilayer body 512 and is an assembly of the plurality of dielectric layers 514 located between the plurality of dielectric layers 514 located between the second main surface 512b and the inner electrode layer 516 closest to the second main surface 512b.

A region interposed between the first outer portion 515b1 and the second outer layer portion 515b2 is the effective layer portion 515a. The number of the dielectric layers 514 laminated is not particularly limited, but is preferably 50 or less, including the first outer layer portion 515b1 and the second outer layer portion 515b2. The thickness of each of the dielectric layers 514 is preferably, for example, about 0.2 μm or more and about 10.0 μm or less.

A region interposed between the first outer layer portion 515b1 and the second outer layer portion 515b2 is the effective layer portion 515a. That is, the effective layer portion 515a is a region where the inner electrode layers 516 are laminated.

The dielectric layers 514 can be made, for example, from a dielectric material. For example, a dielectric ceramic material including BaTiO₃, CaTiO₃, SrTiO₃, or CaZnO₃ as a main component can be used as the dielectric material. A material may be used in which a subcomponent, such as a Mn compound, an Fe compound, a Cr compound, a Co compound, or a Ni compound, is added to the main component in an amount smaller than the amount of the main component included.

The dielectric layers 514 can include a plurality of crystal grains including a perovskite-type compound based on BaTiO₃ as a basic structure. Smaller thicknesses of the dielectric layers 514 result in greater capacitance of the capacitor. Thus, a crystal grain size of about 1 μm or less is preferred, for example.

The dielectric layer 514 for the effective layer portion 515a is formed of dielectric ceramic particles having a perovskite structure and mainly including a perovskite compound including, for example, Ba and Ti.

At least one of Si, Mg, Ba, or Mn may be added as an additive to the main component. The additive is present between the ceramic particles.

The dielectric layers 514 for the first outer layer portion 515b1 and the second outer layer portion 515b2 are made of the same dielectric ceramic material as the dielectric layers 514 for the effective layer portion 515a. The dielectric layers 514 for the first outer layer portion 515b1 and the second outer layer portion 515b2 may be made of a material different from that of the dielectric layers 514 for the effective layer portion 515a.

When each of the dielectric layers 514 for the first outer layer portion 515b1 and the second outer layer portion 515b2 has a multilayer structure, as compared with the Si segregation portions of the dielectric layers 514 located closest to the first inner electrode layer 16a and the second inner electrode layer 16b, the other dielectric layers 514 preferably have more segregation portions. This makes it possible to improve the flexural strength of the multilayer ceramic capacitor in the height direction x.

Each of the dielectric layers 514 for the first outer layer portion 515b1 and the second outer layer portion 515b2 may have a multilayer or single-layer structure.

Each of the first side surface 512c, the second side surface 512d, the third side surface 512e, and the fourth side surface 512f is curved from the first main surface 512a to the second main surface 512b.

The first main surface 512a is preferably curved across each of the first side surface 512c, the second side surface 512d, the third side surface 512e, and the fourth side surface 512f.

The second main surface 512b is preferably curved across each of the first side surface 512c, the second side surface 512d, the third side surface 512e, and the fourth side surface 512f.

Each of the first side surface 512c, the second side surface 512d, the third side surface 512e, and the fourth side surface 512f is preferably curved from the first main surface 512a to the second main surface 512b, and the radius of curvature thereof is preferably about 5/2 or less of the thickness dimension of the multilayer body 512 12 in the height direction x at the central portion of the multilayer body 12 in the length direction Z.

A silane coupling agent may be provided on a surface of the multilayer body 512. A silane coupling agent is preferably provided on at least one of the first main surface 512a and the second main surface 512b. More preferably, the silane coupling agent may be provided on each of the first main surface 512a and the second main surface 512b. The silane coupling agent may be provided on the first side surface 512c and the second side surface 512d. In this case, the silane coupling agent is preferably provided on a part or the whole of a portion of each of the first side surface 512c and the second side surface 512d where the first outer electrodes 524a and the second outer electrodes 524b are not provided.

When the silane coupling agent layer is provided, the penetration of moisture, flux, and so forth from the outside into the multilayer body 512 can be inhibited. Accordingly, corrosion due to an organic acid included in the flux can be inhibited at the time of flux mounting, so that a decrease in moisture resistance reliability can be inhibited.

The silane coupling agent layer is preferably made of a fluorine-based silane coupling agent or a carbon-based silane coupling agent.

The fluorine-based silane coupling agent included in the silane coupling agent layer is preferably a silane coupling agent represented by:

CF₃-(CF₂)ₙ₁-R-Si(O-R′)₃

(where n1 is an integer of 0 or more, R is a substituent or alkylene group including Si or O, and R′ is an alkyl group). For example, n1 may be an integer of 0 or more and 7 or less. R′ may be a methyl group or an ethyl group.

The silane coupling agent includes at least one alkoxy

group, which is a reactive group. The silane coupling agent includes one or more perfluoroalkyl groups.

Examples of the fluorine-based silane coupling agent that can be used include CF₃(CF₂)₅(CH₂)₂Si(OCH₃)₃, CF₃(CF₂)₃(CH₂)₂Si(OCH₃)₃, CF₃(CF₂)₃(CH₂)₂Si(OC₂H₅)₃, CF₃(CF₂)₄(CH₂)₂Si(OCH₃)₃, CF₃CH₂O (CH₂)₁₅Si(OCH₃)₃, CF₃(CH₂)₂Si(CH₃)₂(CH₂)₁₅Si(OCH₃)₃, CF₃(CF₂)₃(CH₂)₂Si(CH₃)₂(CH₂)₉Si(OCH₃)₃, CF₃COO(CH₂)₁₅Si(OCH₃)₃, CF₃(CF₂)₅(CH₂)₂Si(OC₂H₅)₃, CF₃(CF₂)₄(CH₂)₂Si(CH₃)₂(CH₂)₉Si(OC₂H₅)₃, CF₃(CF₂)₄(CH₂)₂Si(CH₃)₂(CH₂)₆Si(OC₂H₅)₃, CF₃(CF₂)₄(CH₂)₂Si(OC₂H₅)₃, CF₃CH₂O(CH₂)₁₅Si(OC₂H₅)₃, CF₃COO(CH₂)₁₅Si(OC₂H₅)₃, CF₃(CF₂)₄CONH(CH₂)₃Si(OCH₃)₃, CF₃(CF₂)₄CONH(CH₂)₃Si(OCH₃)₃, CF₃(CF₂)₅CONH(CH₂)₃Si(OC₂H₅)₃, and CF₃(CF₂)₄CONH(CH₂)₃Si(OC₂H₅)₃.

The carbon-based silane coupling agent included in the silane coupling agent layer is preferably a silane coupling agent represented by:

(RO)₃Si-(CH₂)ₙ₂-CH₃

(where n2 is an integer of 0 or more and 17 or less, and R is a methyl group or an ethyl group).

Examples of the carbon-based silane coupling agent that can be used include Shin-Etsu Chemical Co., Ltd.: KBM 3103C (decyltrimethoxysilane), KBM-13 (methyltrimethoxysilane), KBE-13 (methyltriethoxysilane), KBM 3033 (n-propyltrimethoxysilane), KBE 3033 (n-propyltriethoxysilane), KBM 3063 (hexyltrimethoxysilane), and KBE 3063 (hexyltriethoxysilane); and Tokyo Chemical Industry Co., Ltd. (TCI): octadecyltrimethoxysilane.

As the carbon-based silane coupling agent other than the above, the following silane coupling agents can also be used: Shin-Etsu Chemical Co., Ltd.: KBM-103 (phenylmethoxysilane), KBM-3066 (1,6-bis(trimethoxysilyl)hexane), and KBM-9659 (tris-(trimethoxysilylpropyl)isocyanurate).

### Inner Electrode Layer

As illustrated in FIGS. 8 to 11, the inner electrode layers 516 include a plurality of first inner electrode layers 516a and a plurality of second inner electrode layers 516b. The first inner electrode layers 516a and the second inner electrode layers 516b are alternately laminated with the dielectric layers 514 interposed therebetween in the direction connecting the first main surface 512a and the second main surface 512b.

The first inner electrode layers 516a are disposed on the surfaces of the dielectric layers 514. The first inner electrode layers 516a each include a first counter electrode portion 518a opposite the first main surface 512a and the second main surface 512b and opposite the second inner electrode layers 516b, and are laminated in the direction connecting the first main surface 512a and the second main surface 512b.

Each of the second inner electrode layers 516b is disposed on a surface of a corresponding one of the dielectric layers 514 different from the dielectric layers 514 on which the first inner electrode layers 516a are disposed. The second inner electrode layers 516b each include a second counter electrode portion 518b opposite the first main surface 512a and the second main surface 512b, and are laminated in a direction connecting the first main surface 512a and the second main surface 512b.

As illustrated in FIG. 10 and FIGS. 12A to 12D, the first inner electrode layers 516a extend to the first side surface 512c and the third side surface 512e of the multilayer body 512 with first extension electrode portions 520a, and extend to the second side surface 512d and the fourth side surface 512f of the multilayer body 512 with second extension electrode portions 520b. The width of the first extension electrode portions 520a extending to the first side surface 512c may be substantially equal to the width of the first extension electrode portions 520a extending to the third side surface 512e. The width of the second extension electrode portions 520b extending to the second side surface 512d may be substantially equal to the width of the second extension electrode portions 520b extending to the fourth side surface 512f.

That is, the first extension electrode portions 520a extend to the first side surface 512c side of the multilayer body 512. The second extension electrode portions 520b extend to the second side surface 512d side of the multilayer body 512.

As illustrated in FIG. 10 and FIGS. 12A to 12D, the second inner electrode layers 516b extend to the first side surface 512c and the fourth side surface 512f of the multilayer body 512 with the third extension electrode portions 521a, and extend to the second side surface 512d and the third side surface 512e of the multilayer body 512 with the fourth extension electrode portions 521b. The width of the third extension electrode portions 521a extending to the first side surface 512c may be substantially equal to the width of the third extension electrode portions 521a extending to the fourth side surface 512f. The width of the fourth extension electrode portions 521b extending to the second side surface 512d may be substantially equal to the width of the fourth extension electrode portions 521b extending to the third side surface 512e.

That is, the third extension electrode portions 521a extend to the fourth side surface 512f side of the multilayer body 512. The fourth extension electrode portions 521b extend to the third side surface 512e side of the multilayer body 512.

When the multilayer ceramic capacitor 510 is viewed from the lamination direction, a straight line connecting the first extension electrode portions 520a and the second extension electrode portions 520b of the first inner electrode layers 516a and a straight line connecting the third extension electrode portions 521a and the fourth extension electrode portions 521b of the second inner electrode layers 516b preferably intersect.

On the first side surface 512c, the second side surface 512d, the third side surface 512e, and the fourth side surface 512f of the multilayer body 512, the first extension electrode portions 520a of the first inner electrode layers 516a and the fourth extension electrode portions 521b of the second inner electrode layers 516b preferably extend to opposite positions, and the second extension electrode portions 520b of the first inner electrode layers 516a and the third extension electrode portions 521a of the second inner electrode layers 516b preferably extend to opposite positions.

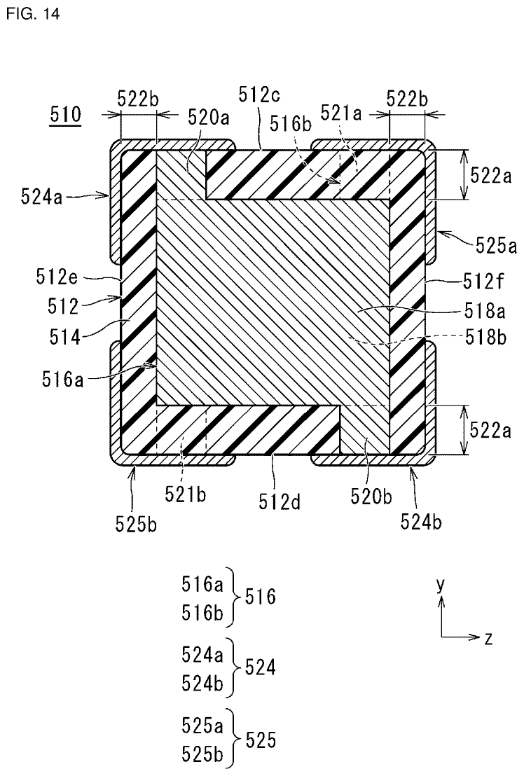

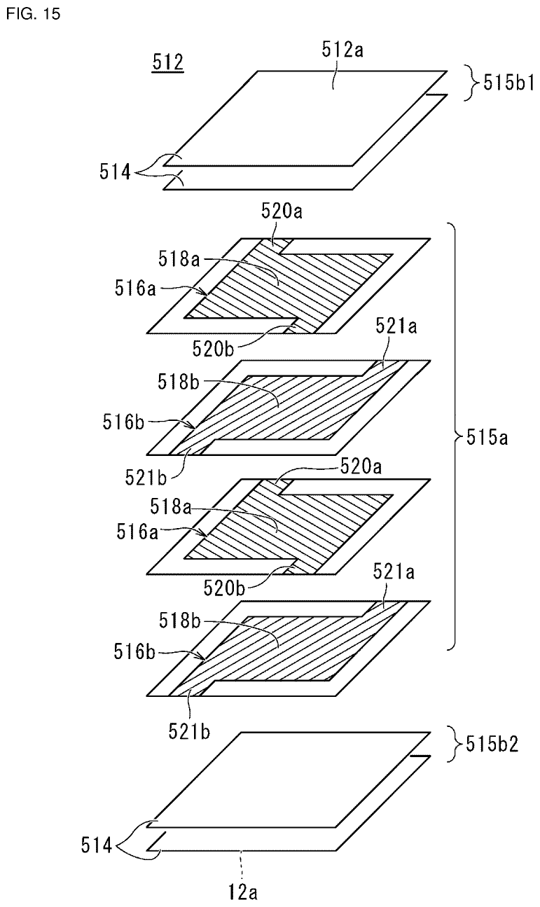

As illustrated in FIGS. 14 and 15, the first extension electrode portions 520a of the first inner electrode layers 516a may extend to only the first side surface 512c of the multilayer body 512. The second extension electrode portions 520b of the first inner electrode layers 516a may extend to only the second side surface 512d of the multilayer body 512.

As illustrated in FIGS. 14 and 15, the third extension electrode portions 521a of the first inner electrode layers 516a may extend to only the fourth side surface 512f of the multilayer body 512. The fourth extension electrode portions 521b of the first inner electrode layers 516a may extend to only the third side surface 512e of the multilayer body 512.

As illustrated in FIG. 10, the multilayer body 512 includes end portions (L gaps) 522b of the multilayer body 512, the end portions being located between one end of each first counter electrode portion 518a in the length direction z and the third side surface 512e, and between the other end of each second counter electrode portion 518b in the length direction z and the fourth side surface 512f.

As illustrated in FIG. 10, the multilayer body 512 includes side portions (W gaps) 522a of the multilayer body 512, the side portions being located between one end of each first counter electrode portion 518a in the width direction y and the first side surface 512c and between the other end of each second counter electrode portion 518b in the width direction y and the second side surface 512d.

In the multilayer body 512, each of the dielectric layers 514 for the effective layer portion 515a may be interposed between the first inner electrode layer 516a and the first inner electrode layer 516a. In this case, the first inner electrode layer 516a and the first inner electrode layer 516a are successively arranged with the dielectric layer 514 for the effective layer portion 515a interposed therebetween.

Each dielectric layer 514 for the effective layer portion 515a may be interposed between the second inner electrode layer 516b and the second inner electrode layer 516b. In this case, the second inner electrode layer 516b and the second inner electrode layer 516b are successively arranged with the dielectric layer 514 for the effective layer portion 515a interposed therebetween.

The shape of the first counter electrode portion 518a of the first inner electrode layer 516a is preferably, but not particularly limited to, a rectangular shape in plan view. The corner portions may be rounded in plan view, or the corner portions may be formed obliquely (tapered) in plan view. The corner portions may be tapered so as to be inclined toward either side in plan view.

The shape of the first extension electrode portion 520a and the second extension electrode portion 520b of the first inner electrode layer 516a is preferably, but not particularly limited to, a rectangular shape in plan view. The corner portions may be rounded in plan view, or the corner portions may be formed obliquely (tapered) in plan view. The corner portions may be tapered so as to be inclined toward either side in plan view.

The shape of the second counter electrode portion 518b of the second inner electrode layer 516b is preferably, but not particularly limited to, a rectangular shape in plan view. The corner portions may be rounded in plan view, or the corner portions may be formed obliquely (tapered) in plan view. The corner portions may be tapered so as to be inclined toward either side in plan view.

The shape of the third extension electrode portion 521a and the fourth extension electrode portion 521b of the second inner electrode layer 516b is preferably, but not particularly limited to, a rectangular shape in plan view. The corner portions may be rounded in plan view, or the corner portions may be formed obliquely (tapered) in plan view. The corner portions may be tapered so as to be inclined toward either side in plan view.

The material of the inner electrode layers 516 may be, but is not limited to, a metal, e.g., Ni, Cu, Ag, Pd, or Au, or an appropriate conductive material, such as an Ag-Pd alloy, including one of these metals.

The number of the first inner electrode layers 516a and the second inner electrode layers 516b laminated is appropriately changed in accordance with the size and so forth. When the number of the first inner electrode layers 516a is increased, an increase in direct current resistance can be inhibited.

The first inner electrode layers 516a may be successively laminated in the height direction x, or the first inner electrode layers 516a and the second inner electrode layers 516b may be alternately laminated.

In the multilayer body 512, a first dummy electrode layer may be disposed on an extension line of the first extension electrode portion 520a of each first inner electrode layer 516a in the height direction x.

A second dummy electrode layer may be disposed on an extension line of the second extension electrode portion 520b of the first inner electrode layer 516a in the height direction x.

A third dummy electrode layer may be disposed on an extension line of the third extension electrode portion 521a of each second inner electrode layer 516b in the height direction x.

A fourth dummy electrode layer may be disposed on an extension line in the height direction x of the fourth extension electrode portion 521b of the second inner electrode layer 516b.

The first dummy electrode layer and the second dummy electrode layer may be disposed in the first outer layer portion 515b1 and the second outer layer portion 515b2.

Preferably, the first dummy electrode layer is disposed on the same plane as the second inner electrode layer 516b and has the same thickness as the second inner electrode layer 516b. At this time, the first dummy electrode layer is not electrically connected to the second inner electrode layer 516b.

Preferably, the second dummy electrode layer is disposed on the same plane as the second inner electrode layer 516b and has the same thickness as the second inner electrode layer 516b. At this time, the second dummy electrode layer is not electrically connected to the second inner electrode layer 516b.

Preferably, the third dummy electrode layer is disposed on the same plane as the first inner electrode layer 516a and has the same thickness as the first inner electrode layer 516a. At this time, the third dummy electrode layer is not electrically connected to the first inner electrode layer 516a.

Preferably, the fourth dummy electrode layer is disposed on the same plane as the first inner electrode layer 516a and has the same thickness as the first inner electrode layer 516a. At this time, the fourth dummy electrode layer is not electrically connected to the first inner electrode layer 516a.

The current path can be shortened by reducing the coverage of the first dummy electrode and the second dummy electrode. The dummy layers can be used as starting points of plating when direct plating layers, which will be described below, are formed. Thus, a uniform plating film can be formed.

The first extension electrode portion 520a and the second extension electrode portion 520b of the first inner electrode layer 516a may be curved.

The third extension electrode portion 521a and the fourth extension electrode portion 521b of the second inner electrode layer 516b may be curved.

In this case, the extension electrode portions may be disposed so as to be curved toward either the first main surface 512a or the second main surface 512b. In this case, the current path can be shortened by using the curved surface as a mounting surface.

Of the first inner electrode layers 516a extending to the first side surface 512c, the third side surface 512e, the second side surface 512d, and the fourth side surface 512f, the distance between the layer located closest to the first main surface 512a and the layer located closest to the second main surface 512b may be smaller than the distance between the portion located closest to the first main surface 512a and the portion located closest to the second main surface 512b, of the first counter electrode portions 518a of the first inner electrode layers 516a.

Of the second inner electrode layers 516b extending to the second side surface 512d, the fourth side surface 512f, the first side surface 512c, and the third side surface 512e, the distance between the layer located closest to the first main surface 512a and the layer located closest to the second main surface 512b may be smaller than the distance between the portion located closest to the first main surface 512a and the portion located closest to the second main surface 512b, of the second counter electrode portions 518b of the second inner electrode layers 516b.

To increase the capacitance of the capacitor, the area of each of the first inner electrode layer 516a and the second inner electrode layer 516b of the inner electrode layers 516 is increased. Thus, the LW area coverage of each of the first inner electrode layer 516a and the second inner electrode layer 516b is preferably about 90% or more, for example. The LW plane coverage is defined as a ratio obtained by subtracting the area of the void from the area inside the edge portion of the first inner electrode layer 516a or the second inner electrode layer 516b when viewed from the LW plane of the multilayer body 512.

When the LW plane coverage is high, the capacitance of the capacitor is high. However, even if the LW plane coverage is low, the dielectric layers 514 are bonded to each other at the gap to increase the bonding strength between the layers. Thus, delamination is less likely to occur.

Each first inner electrode layer 516a preferably has a uniform thickness. The thickness of an edge portion of the first inner electrode layer 516a may be larger than the thickness of the central portion. For the edge portion thicker than the central portion, the coverage is improved, the current path is shortened, and the ESL characteristics are improved.

The thickness of an edge portion of the first inner electrode layer 516a may be smaller than the thickness of the central portion. When the edge portion is thinner than the central portion, the step height corresponding to the thickness of the first inner electrode layer 516a is reduced, thus inhibiting structural defects.

Similarly, each second inner electrode layer 516b preferably has a uniform thickness. The thickness of an edge portion of the second inner electrode layer 516b may be larger than the thickness of the central portion. For the edge portion thicker than the central portion, the coverage is improved, the current path is shortened, and the ESL characteristics are improved.

The thickness of an edge portion of the second inner electrode layer 516b may be larger than the thickness of the central portion. The thickness of an edge portion of the second inner electrode layer 516b may be smaller than the thickness of the central portion. When the edge portion is thinner than the central portion, the step height corresponding to the thickness of the second inner electrode layer 516b is reduced, thus inhibiting structural defects.

The thickness of each of the first inner electrode layer 516a and the second inner electrode layer 516b of the inner electrode layers 516 is preferably, for example, about 0.1 μm or more and about 0.8 μm or less.

The total number of the first inner electrode layers 516a and the second inner electrode layers 516b of the inner electrode layers 516 is preferably, for example, about 20 or more and about 60 or less.

### Outer Electrode

As illustrated in FIGS. 7 to 10, the multilayer body 512 includes the outer electrodes 524 and 525. The thickness of each of the outer electrodes 524 and 525 is preferably, for example, about 1 μm or more and about 30.0 μm or less.

The outer electrodes 524 include underlying electrode layers 526 and plating layers 528 disposed so as to cover the underlying electrode layers 526.

The outer electrodes 525 include underlying electrode layers 527 and plating layers 529 disposed so as to cover the underlying electrode layers 527.

The outer electrodes 524 include a first outer electrode 524a and a second outer electrode 524b.

The first outer electrode 524a is disposed so as to cover the first extension electrode portions 520a on the first side surface 512c and the third side surface 512e, and is disposed so as to cover a portion of the first main surface 512a and a portion of the second main surface 512b. The first outer electrode 524a is electrically connected to the first extension electrode portions 520a of the first inner electrode layers 516a.

The first outer electrode 524a may be disposed so as to cover the first extension electrode portions 520a only on the first side surface 512c.

The second outer electrode 524b is disposed so as to cover the second extension electrode portions 520b on the second side surface 512d and the fourth side surface 512f, and is disposed so as to cover a portion of the first main surface 512a and a portion of the second main surface 512b. The second outer electrode 524b is electrically connected to the second extension electrode portions 520b of the first inner electrode layers 516a.

The second outer electrode 524b may be disposed so as to cover the second extension electrode portions 520b only on the second side surface 512d.

The outer electrodes 525 include a third outer electrode 525a and a fourth outer electrode 525b.

The third outer electrode 525a is disposed so as to cover the third extension electrode portions 521a on the first side surface 512c and the fourth side surface 512f, and is disposed so as to cover a portion of the first main surface 512a and a portion of the second main surface 512b. The third outer electrode 525a is electrically connected connected to the third extension electrode portions 521a of the second inner electrode layers 516b.

The third outer electrode 525a may be disposed so as to cover the third extension electrode portions 521a only on the fourth side surface 512f.

The fourth outer electrode 525b is disposed so as to cover the fourth extension electrode portions 521b on the second side surface 512d and the third side surface 512e, and is disposed so as to cover a portion of the first main surface 512a and a portion of the second main surface 512b. The fourth outer electrode 525b is electrically connected to the fourth extension electrode portions 521b of the second inner electrode layers 516b.

The fourth outer electrode 525b may be disposed so as to cover the fourth extension electrode portions 521b only on the third side surface 512e.

In the multilayer body 512, the first counter electrode portion 518a of the first inner electrode layer 516a and the second counter electrode portion 518b of the second inner electrode layer 516b are opposite each other with the dielectric layer 514 interposed therebetween, thus generating an electrostatic capacitance. Therefore, an electrostatic capacitance can be formed between the first outer electrode 524a and the second outer electrode 524b to which the first inner electrode layers 516a are connected, and the third outer electrode 525a and the fourth outer electrode 525b to which the second inner electrode layers 516b are connected, thus exhibiting the characteristics of a capacitor.

### Underlying Electrode Layer

The underlying electrode layers 526 include a first underlying electrode layer 526a and a second underlying electrode layer 526b.

The first underlying electrode layer 526a is disposed so as to cover the first extension electrode portions 520a on the first side surface 512c and the third side surface 512e, and is disposed so as to cover a portion of the first main surface 512a and a portion of the second main surface 512b.

The second underlying electrode layer 526b is disposed so as to cover the second extension electrode portions 520b on the second side surface 512d and the fourth side surface 512f, and is disposed so as to cover a portion of the first main surface 512a and a portion of the second main surface 512b.

The underlying electrode layers 527 include a third underlying electrode layer 527a and a fourth underlying electrode layer 527b.

The third underlying electrode layer 527a is disposed so as to cover the third extension electrode portions 521a on the first side surface 512c and the fourth side surface 512f, and is disposed so as to cover a portion of the first main surface 512a and a portion of the second main surface 512b.

The fourth underlying electrode layer 527b is disposed so as to cover the fourth extension electrode portions 521b on the second side surface 512d and the third side surface 512e, and is disposed so as to cover a portion of the first main surface 512a and a portion of the second main surface 512b.

Each of the first underlying electrode layer 526a, the second underlying electrode layer 526b, the third underlying electrode layer 527a, and the fourth underlying electrode layer 527b includes at least one selected from a baked layer, a thin film layer, a fired electrode layer, and the like.

### For Baked Layer

Each of the underlying electrode layers 526 as baked layers includes a glass component and a metal. The glass component includes at least one selected from B, Si, Ba, Mg, Al, Li, and the like.

The metal of the baked layer includes, for example, at least one selected from Cu, Ni, Ag, Pd, an Ag-Pd alloy, or Au, and the like.

The baked layer may include a plurality of layers.

The baked layer is formed by applying a conductive paste including glass and metal to the multilayer body and then baking the paste. The baked layer may be formed by firing simultaneously with the inner electrode layers 516, or may be formed by firing the inner electrode layers 516 and then baking the paste.

In the case of the baked layer, the thickness of the first underlying electrode layer 526a located on the first side surface 512c and the third side surface 512e at the central portion in the height direction x is preferably, for example, 1 μm or more and 11 μm or less. The thickness of the second underlying electrode layer 526b located on the second side surface 512d and the fourth side surface 512f at the central portion in the height direction x is preferably, for example, about 1 μm or more and about 11 μm or less.

When the first underlying electrode layer 526a as a baked layer is disposed on the first main surface 512a and the second main surface 512b, the thickness of the first underlying electrode layer 526a located on the first main surface 512a and the second main surface 512b at the central portion in the height direction x is preferably, for example, about 1 μm or more and about 11 μm or less.

When the second underlying electrode layer 526b as a baked layer is disposed on the first main surface 512a and the second main surface 512b, the thickness of the second underlying electrode layer 526b located on the first main surface 512a and the second main surface 512b at the central portion in the height direction x is preferably, for example, about 1 μm or more and about 11 μm or less.

In the case of the baked layer, the thickness of the third underlying electrode layer 527a located on the first side surface 512c and the fourth side surface 512f at the central portion in the height direction x is preferably, for example, about 1 μm or more and about 11 μm or less. The thickness of the fourth underlying electrode layer 527b located on the second side surface 512d and the third side surface 512e at the central portion in the height direction x is preferably, for example, about 1 μm or more and about 11 μm or less.

When the third underlying electrode layer 527a as a baked layer is disposed on the first main surface 512a and the second main surface 512b, the thickness of the third underlying electrode layer 527a located on the first main surface 512a and the second main surface 512b at the central portion in the height direction x is preferably, for example, about 1 μm or more and about 11 μm or less.

When the fourth underlying electrode layer 527b as a baked layer is disposed on the first main surface 512a and the second main surface 512b, the thickness of the fourth underlying electrode layer 527b located on the first main surface 512a and the second main surface 512b at the central portion in the height direction x is preferably, for example, about 1 μm or more and about 11 μm or less.

### For Thin Film Layer

The underlying electrode layers 526 and 527 formed of thin film layers are preferably formed by a thin film formation method, such as a sputtering method or a vapor deposition method. In particular, the underlying electrode layers 526 and 527 formed of thin film layers are preferably sputtered electrodes formed by a sputtering method. When the thin film layers are formed by the sputtering method, the thin film layers can be detected, for example, by a calibration curve method for the relevant metal species with an X-ray fluorescence spectrometer. The thin film layers can also be detected from the actual image observed with a scanning microscope of a component section obtained by FIB. Electrodes formed by the sputtering method will be described below.

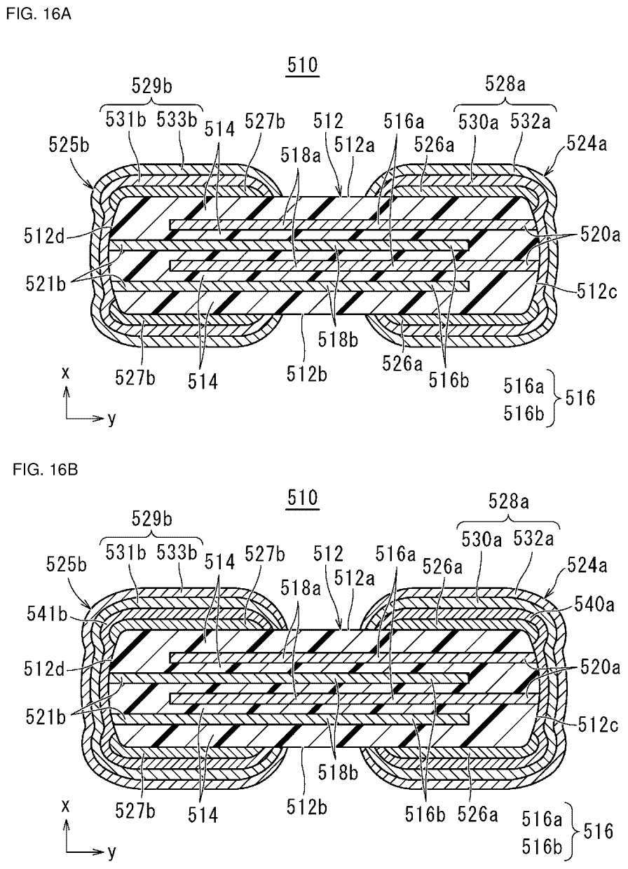

As illustrated in FIG. 16A, the underlying electrode layers 526 and 527 formed of the thin film layers by the sputtering method are layers in which metal particles are deposited.

In the underlying electrode layers 526 formed of the thin film layers by the sputtering method, the first underlying electrode layers 526a are preferably located on a portion of the first main surface 512a and a portion of the second main surface 512b and are also located on a portion of the corner portion where the first main surface 512a, the first side surface 512c, and the third side surface 512e intersect, and on a portion of the corner portion where the second main surface 512b, the first side surface 512c, and the third side surface 512e intersect. Specifically, the first underlying electrode layers 526a are preferably arranged from the first main surface 512a to about 50% of the thickness of the first outer layer portion 515b1 and from the second main surface 512b to about 50% of the thickness of the second outer layer portion 515b2, for example.

Although not illustrated, in the underlying electrode layers 526 formed of the thin film layers by the sputtering method, similarly, the second underlying electrode layers 526b are located on a portion of the first main surface 512a and a portion of the second main surface 512b, and are also located on a portion of the corner portion where the first main surface 512a, the second side surface 512d, and the fourth side surface 512f intersect, and on a portion of the corner portion where the second main surface 512b, the second side surface 512d, and the fourth side surface 512f intersect. Specifically, the second underlying electrode layers 526b are preferably arranged from the first main surface 512a to about 50% of the thickness of the first outer layer portion 515b1 and from the second main surface 512b to about 50% of the thickness of the second outer layer portion 515b2, for example.

Although not illustrated, in the underlying electrode layers 527 formed of the thin film layers by the sputtering method, the third underlying electrode layers 527a are located on a portion of the first main surface 512a and a portion of the second main surface 512b, and are also located on a portion of the corner portion where the first main surface 512a, the first side surface 512c, and the fourth side surface 512f intersect, and on a portion of the corner portion where the second main surface 512b, the first side surface 512c, and the fourth side surface 512f intersect. Specifically, the third underlying electrode layers 527a are preferably arranged from the first main surface 512a to about 50% of the thickness of the first outer layer portion 515b1 and from the second main surface 512b to about 50% of the thickness of the second outer layer portion 515b2, for example.

As illustrated in FIG. 16A, in the underlying electrode layers 527 formed of the thin film layers by the sputtering method, similarly, the fourth underlying electrode layers 527b are located on a portion of the first main surface 512a and a portion of the second main surface 512b, and are also located on a portion of the corner portion where the first main surface 512a, the second side surface 512d, and the third side surface 512e intersect, and on a portion of the corner portion where the second main surface 512b, the second side surface 512d, and the third side surface 512e intersect. Specifically, the fourth underlying electrode layers 527b are preferably arranged from the first main surface 512a to about 50% of the thickness of the first outer layer portion 515b1 and from the second main surface 512b to about 50% of the thickness of the second outer layer portion 515b2, for example.

Hitherto, the thin film layers have been arranged only on the first main surface 512a and the second main surface 512b. Thus, when the outer layers are thick, the distances between the inner electrode layers 516 and the underlying electrode layers 526 and 527, which are thin film layers, are large, and direct plating layers described below may be depressed. However, when the thin film layers extend to a portion of the side surface, it can be formed to have a uniform thickness upon formation of the direct plating layers, making it possible to improve moisture resistance.

The underlying electrode layers 526 and 527 formed of the thin film layers may be located only on the first main surface 512a. In this case, although not illustrated, the outer electrodes are substantially L-shaped. Thus, the dimension in the lamination direction can be reduced by the thickness of the outer electrodes.

The underlying electrode layers 526 and 527 formed of the thin film layers may be located only on a portion of the first main surface 512a and a portion of the second main surface 512b, and need not extend to each of the first side surface 512c, the second side surface 512d, the third side surface 512e, or the fourth side surface 512f.

The underlying electrode layers 526 and 527 formed of the thin film layers have a thickness of 1 μm or less in the height direction x connecting the first main surface 512a and the second main surface 512b.

### For Fired Electrode Layer

The underlying electrode layers 526 and 527 formed by fired electrode layers are layers including a metal component and a dielectric material that is the same component as the dielectric layers 14.

The underlying electrode layers 526 and 527 formed of the fired electrode layers are arranged on the first main surface 512a, the second main surface 512b, the first side surface 512c, the second side surface 512d, the third side surface 512e and the fourth side surface 512f. The underlying electrode layers 526 and 527 may be formed by firing simultaneously with the multilayer body 512, or by baking after the multilayer body 512 is fired.

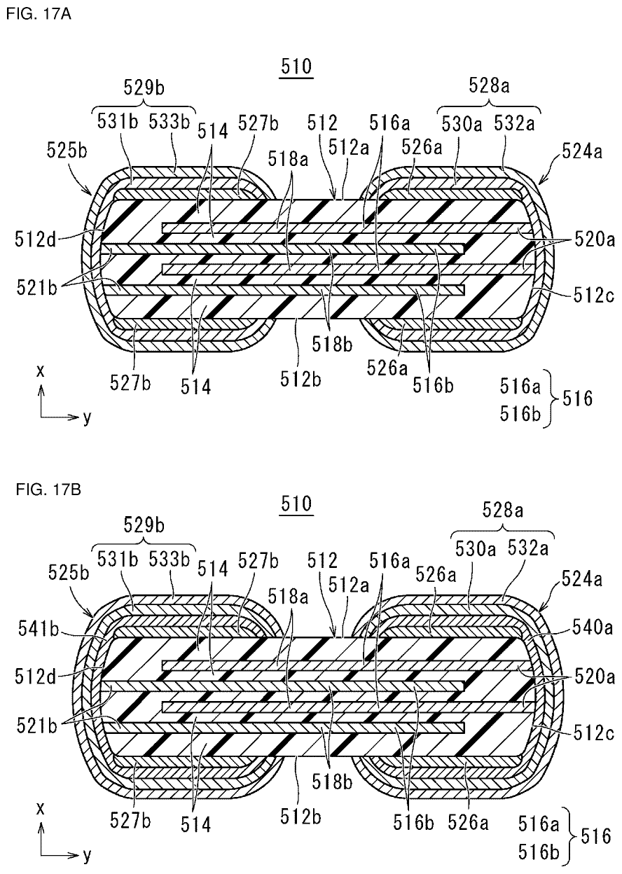

As illustrated in FIG. 17A, in the underlying electrode layers 526 formed of the fired electrode layers, preferably, the first underlying electrode layers 526a are located only on a portion of the first main surface 512a and a portion of the second main surface 512b, and are arranged so as not to extend to the first side surface 512c or the third side surface 512e.

Although not illustrated, in the underlying electrode layers 526 formed of the fired electrode layers, it is preferred that similarly, the second underlying electrode layers 526b be located only on a portion of the first main surface 512a and a portion of the second main surface 512b and be arranged so as not to extend to the second side surface 512d or the fourth side surface 512f.

Although not illustrated, in the underlying electrode layers 527 formed of the fired electrode layers, preferably, the third underlying electrode layers 527a are located only on a portion of the first main surface 512a and a portion of the second main surface 512b, and are arranged so as not to extend to the first side surface 512c or the fourth side surface 512f.

As illustrated in FIG. 17A, in the underlying electrode layers 527 formed of the fired electrode layers, it is preferred that similarly, the fourth underlying electrode layers 527b are located only on a portion of the first main surface 512a and a portion of the second main surface 512b, and are arranged so as not to extend to the second side surface 512d or the third side surface 512e.

The underlying electrode layers 526 and 527 formed of the fired electrode layers may be located only on the first main surface 512a. In this case, although not illustrated, the outer electrodes are substantially L-shaped. Thus, the dimension in the lamination direction can be reduced by the thickness of the outer electrodes.

The underlying electrode layers 526 and 527 formed of the fired electrode layers formed by a screen printing method may be located on a portion of the first main surface 512a and a portion of the second main surface 512b, and may also extend to each of the first side surface 512c, the second side surface 512d, the third side surface 512e, and the fourth side surface 512f.

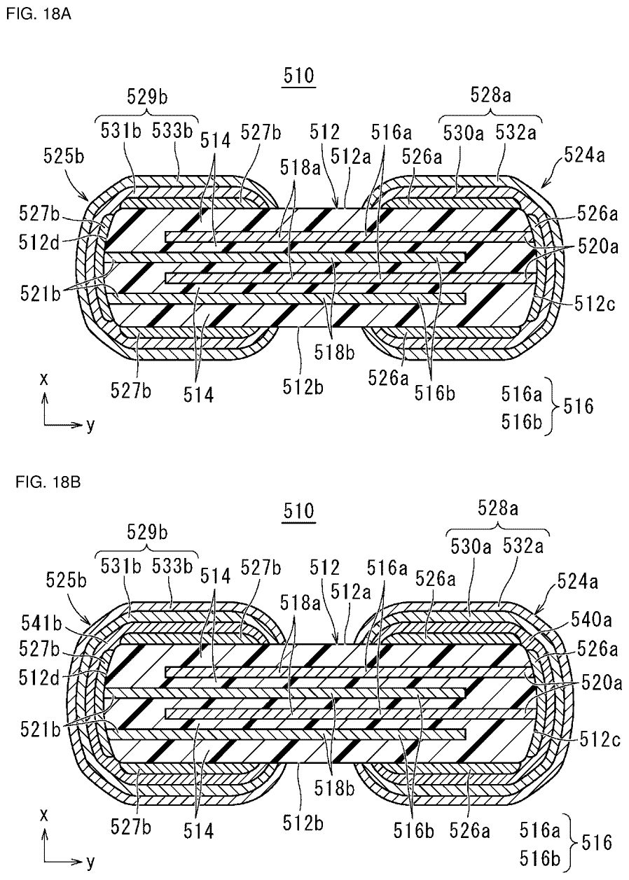

As illustrated in FIG. 18A, the underlying electrode layers 526 formed of the fired electrode layers may be separately arranged on the first main surface 512a and the second main surface 512b and on the side surfaces. Similarly, the underlying electrode layers 527 formed of the fired electrode layers may be separately arranged on the first main surface 512a and the second main surface 512b and on the side surfaces.

The underlying electrode layers 526 and 527 formed of the fired electrode layers may be discontinuously arranged. The term “discontinuously” used here indicates that the first underlying electrode layers 526a of the underlying electrode layers 526 are in a state of partial presence on the first main surface 512a, the second main surface 512b, the first side surface 512c, and the third side surface 512e, and that the second underlying electrode layers 526b of the underlying electrode layers 526 are in a state of partial presence on the first main surface 512a, the second main surface 512b, the first side surface 512c, and the fourth side surface 512f. It also indicates that the third underlying electrode layers 527a of the underlying electrode layers 527 are in a state of partial presence on the first main surface 512a, the second main surface 512b, the second side surface 512d, and the third side surface 512e, and that the fourth underlying electrode layers 527b of the underlying electrode layers 527 are in a state of partial presence on the first main surface 512a, the second main surface 512b, the second side surface 512d, and the fourth side surface 512f.

When the underlying electrode layers 526 and 527 formed of the fired electrode layers are discontinuously arranged, the surface area of the conductive component increases, thus improving the bondability of the direct plating layers described below.

However, as illustrated in FIG. 8 and the like, the underlying electrode layers 526 and 527 formed of the fired electrode layers and arranged on the first main surface 512a and the second main surface 512b may be partially arranged over the first side surface 512c, the second side surface 512d, the third side surface 512e, and the fourth side surface 512f, as appropriate.

In this case, the distance between any one of the inner electrode layers 516 closest to the first main surface 512a or the second main surface 512b, which is the starting point of plating of the direct plating layer described below, and the underlying electrode layers 526 and 527 is reduced. Thus, the thickness of the direct plating layer can be formed to have a uniform thickness even on the first outer layer portion 515b1 and the second outer layer portion 515b2, so that the moisture resistance can be improved.

### Plating Layer

As illustrated in FIG. 10, the plating layers 528 include a first plating layer 528a and a second plating layer 528b.

The first plating layer 528a is disposed so as to cover the first underlying electrode layer 526a.

The second plating layer 528b is disposed so as to cover the second underlying electrode layer 526b.

As illustrated in FIG. 10, the plating layers 529 include a third plating layer 529a and a fourth plating layer 529b.

The third plating layer 529a is disposed so as to cover the third underlying electrode layer 527a.

The fourth plating layer 529b is disposed so as to cover the fourth underlying electrode layer 527b.

Each plating layer 528 includes, for example, at least one selected from Cu, Ni, Ag, Pd, an Ag-Pd alloy, Au, and so forth.

Similarly, each plating layer 529 includes, for example, at least one selected from Cu, Ni, Ag, Pd, an Ag-Pd alloy, Au, and so forth.

The plating layers 528 may include a plurality of layers. In the present example embodiment, each plating layer 528 has a two-layer structure of a Ni plating layer and a Sn plating layer. The plating layers 528 include lower plating layers 530 that are Ni plating layers covering the underlying electrode layers 526 and upper plating layers 532 that are Sn plating layers arranged so as to cover the lower plating layers 530. Similarly, the plating layers 529 include lower plating layers 531 and upper plating layers 533 disposed so as to cover the underlying electrode layers 527 and the lower plating layers 531.

The Ni plating layers can inhibit the erosion of the underlying electrode layers 526 and 527 by solder when the multilayer ceramic capacitor is mounted. The Sn plating can improve the wettability of solder when the multilayer ceramic capacitor is mounted, thus facilitating mounting.

When each of the plating layers 528 and 529 has a three-layer structure, a Sn plating layer, a Ni plating, and a Sn plating layer are preferably laminated in this order.

The lower plating layers 530 include a first lower plating layer 530a and a second lower plating layer 530b.

The first lower plating layer 530a is disposed over the surfaces of the multilayer body 512 so as to cover the first underlying electrode layer 526a disposed on the first main surface 512a, the second main surface 512b, the first side surface 512c, and the third side surface 512e.

The second lower plating layer 530b is disposed over the surfaces of the multilayer body 512 so as to cover the second underlying electrode layer 526b exposed on the first main surface 512a, the second main surface 512b, the second side surface 512d, and the fourth side surface 512f.

The lower plating layers 531 include a third lower plating layer 531a and a fourth lower plating layer 531b.

The third lower plating layer 531a is disposed over the surfaces of the multilayer body 512 so as to cover the third underlying electrode layer 527a exposed on the first main surface 512a, the second main surface 512b, the first side surface 512c, and the fourth side surface 512f.

The fourth lower plating layer 531b is disposed over the surfaces of the multilayer body 512 so as to cover the fourth underlying electrode layer 527b exposed on the first main surface 512a, the second main surface 512b, the second side surface 512d, and the third side surface 512e.

The upper plating layers 532 include a first upper plating layer 532a and a second upper plating layer 532b.

The first upper plating layer 532a is disposed so as to cover the first lower plating layer 530a. Specifically, the first upper plating layer 532a is disposed over the first side surface 512c and the third side surface 512e on the surface of the first lower plating layer 530a, and is disposed so as to extend to the first main surface 512a and the second main surface 512b on the surface of the first lower plating layer 530a.

The second upper plating layer 532b is disposed so as to cover the second lower plating layer 530b. Specifically, the second upper plating layer 532b is disposed over the second side surface 512d and the fourth side surface 512f on the surface of the second lower plating layer 530b, and is disposed so as to extend to the first main surface 512a and the second main surface 512b on the surface of the second lower plating layer 530b.

The upper plating layers 533 include a third upper plating layer 533a and a fourth upper plating layer 533b.

The third upper plating layer 533a is disposed so as to cover the third lower plating layer 531a. Specifically, the third upper plating layer 533a is disposed over the first side surface 512c and the fourth side surface 512f on the surface of the third lower plating layer 531a, and is disposed so as to extend to the first main surface 512a and the second main surface 512b on the surface of the third lower plating layer 531a.

The fourth upper plating layer 533b is disposed so as to cover the fourth lower plating layer 531b. Specifically, the fourth upper plating layer 533b is disposed over the second side surface 512d and the third side surface 512e on the surface of the fourth lower plating layer 531b, and is disposed so as to extend to the first main surface 512a and the second main surface 512b on the surface of the fourth lower plating layer 531b.

The plating layers 528 and 529 preferably have a thickness per layer of, for example, about 1 μm or more and about 11 μm or less.

### For Direct Plating Layer

In the outer electrodes 524 and 525, direct plating layers 540 and 541 may be disposed between the underlying electrode layers 526 and 527 and the plating layers 528 and 529. That is, in the multilayer ceramic capacitor, the direct plating layers 540 and 541 may be disposed so as to cover the underlying electrode layers 526 and 527 on the main surfaces 512a and 512b, and may be disposed so as to be electrically connected to the first inner electrode layers 516a or the second inner electrode layers 516b on the side surface 512c or 512d. In this case, the direct plating layers may be formed after a catalyst is disposed on the surfaces of the underlying electrode layers 526 and 527 and the multilayer body 512 as a pretreatment.

The configurations illustrated in FIGS. 16(b) and 17(b) are examples in which the direct plating layers 540 and 541 are disposed between the underlying electrode layers 526 and 527 and the plating layers 528 and 529. That is, the direct plating layers 540 and 541 cover the underlying electrode layers 526 and 527 on the main surfaces 512a and 512b, and cover the inner electrode layers 516 on the side surfaces 521c and 512b.

The direct plating layers 540 and 541 illustrated in FIG. 18B cover the underlying electrode layers 526 and 527 on the main surfaces 512a and 512b and the side surfaces 521c and 512b.

More specifically, as illustrated in FIGS. 16B and 17B, the direct plating layer 540a is disposed so as to cover the first underlying electrode layers 526a arranged on the first main surface 512a and the second main surface 512b, and is also disposed on the surface of the first side surface 512c so as to be electrically connected to the first inner electrode layers 516a exposed on at least the first side surface 512c.

Similarly, although not illustrated, the direct plating layer 540b is disposed so as to cover the second underlying electrode layers 526b arranged on the first main surface 512a and the second main surface 512b, and is also disposed on the surface of the second side surface 512d so as to be electrically connected to the first inner electrode layers 516a exposed on at least the second side surface 512d.

Similarly, although not illustrated, the direct plating layer 541b is disposed so as to cover the third underlying electrode layers 527a arranged on the first main surface 512a and the second main surface 512b, and is also disposed on the surface of the first side surface 512c so as to be electrically connected to the second inner electrode layers 516b exposed on at least the first side surface 512c.

Similarly, as illustrated in FIGS. 16B and 17B, the direct plating layer 541a is disposed so as to cover the fourth underlying electrode layers 527b arranged on the first main surface 512a and the second main surface 512b, and is also disposed on the surface of the second side surface 512d so as to be electrically connected to the second inner electrode layers 516b exposed on at least the second side surface 512d.

Each direct plating layer preferably includes, for example, at least one metal selected from Cu, Ni, Sn, Pb, Au, Ag, Pd, Bi and Zn, or an alloy including the metal.

For example, when the first inner electrode layers 16a and the second inner electrode layers 16b include Ni, the direct plating layers preferably include Cu, which has good bonding properties with Ni.

The direct plating layers preferably have a thickness per layer of, for example, about 1 μm or more and about 11 μm or less.

Preferably, each direct plating layer is free of glass. The proportion of the metal per unit volume of the direct plating layer is preferably about 99% by volume or more, for example.

In the case of the formation of the direct plating layers, since each of the first side surface 512c, the second side surface 512d, the third side surface 512e, and the fourth side surface 512f is curved, the exposed areas of the inner electrode layers 516 are increased as compared with the state where each side surface is flat, and the time for plating formation can be shortened. In addition, it is possible to improve the contact probability between the media and the metal component when the plating is formed.

The dimension of the multilayer ceramic capacitor 510, including the multilayer body 512 and the outer electrodes 524 and 525, in the length direction z is defined as dimension L. The dimension of the multilayer ceramic capacitor 10, including the multilayer body 12 and the outer electrodes 524 and 525, in the height direction x is defined as dimension T. The dimension of the multilayer ceramic capacitor 10, including the multilayer body 12 and the outer electrodes 524 and 525, in the width direction y is defined as dimension W.

With regard to the dimensions of the multilayer ceramic capacitor 510, it is preferred that the dimension L in the length direction z be about 0.1 mm or more and about 6.0 mm or less, the dimension T in the height direction x be about 10 μm or more and about 300 μm or less, and the dimension W in the width direction y be about 0.1 mm or more and about 6.0 mm or less, for example.

In the present example embodiment, each of the first side surface 512c, the second side surface 512d, the third side surface 512e, and the fourth side surface 512f is curved from the first main surface 512a to the second main surface 512b. The radius of curvature thereof is preferably about 5/2 or less of the thickness dimension of the multilayer body 512 in the height direction x at the central portion of the multilayer body 12 in the length direction z.

As a result, the inner electrode layer 516 can have increased exposed area on the first side surface 512c, the second side surface 512d, the third side surface 512e, and the fourth side surface 512f, thus resulting in increased bonding strength between the multilayer body 512 and the conductive component of the outer electrodes 524 and 525. Furthermore, because of the increased exposed area of the conductive component of the outer electrodes 524 and 525, ESR can be controlled at a low level.

The radius of curvature of each of the first side surface 512c, the second side surface 512d, the third side surface 512e, and the fourth side surface 512f of the multilayer body 512 can be measured by the same measurement method as in the first example embodiment.

When the end surface to be exposed for measurement includes the outer electrodes 524 and 525, for the radius of curvature of the first side surface 512c, the edge portions of the first counter electrode portions 518a and the second counter electrode portions 518b that are not extended to the first side surface 512c are used as a reference. For the radius of curvature of the second side surface 512d, the edge portions of the first counter electrode portions 518a and the second counter electrode portions 518b that are not extended to the second side surface 512d are used as a reference. For the radii of curvature of the third side surface 512e and the fourth side surface 512f, the same references are used. The radius of curvature is defined with a position, which is a starting point, shifted by about 5% toward each side surface from a corresponding one of the references, for example.

When the end surface to be exposed for measurement does not include the outer electrodes 524 or 525, for the radius of curvature of the first side surface 512c, the edge portions of the first counter electrode portions 518a and the second counter electrode portions 518b adjacent to the first side surface 512c are used as a reference. For the radius of curvature of the second side surface 512d, the edge portions of the first counter electrode portions 518a and the second counter electrode portions 518b adjacent to the second side surface 512d are used as a reference. The radius of curvature is defined with a position, which is a starting point, shifted by about 5% toward each side surface from a corresponding one of the references.

### 2. Method for Manufacturing Multilayer Ceramic Capacitor

A non-limiting example of a method for manufacturing a multilayer ceramic capacitor that is an example of the multilayer ceramic capacitor according to the second example embodiment will be described below.

Dielectric sheets and a conductive paste for inner electrodes are prepared. The dielectric sheets and the conductive paste for inner electrode layers include a binder (for example, a known organic binder) and a solvent (for example, a known organic binder).

The conductive paste for inner electrodes is applied to the dielectric sheets in predetermined patterns by printing, such as screen printing or gravure printing, to form inner electrode patterns. Specifically, conductive paste layers are formed by applying a paste made of a conductive material to the dielectric sheets by the above-described printing method or the like. The paste made of the conductive material is, for example, a paste in which an organic binder and an organic solvent are added to a metal powder. With regard to the dielectric sheets, dielectric sheets for outer layers on which none of the inner electrode patterns are formed by printing are also prepared.

As a result, dielectric sheets are prepared on which an inner electrode pattern corresponding to the first inner electrode layers 516a is formed, and dielectric sheets are prepared on which an inner electrode pattern corresponding to the second inner electrode layers 516b is formed.

More specifically, a screen plate for forming the first inner electrode layer 516a by printing and a screen plate for forming the second inner electrode layer 516b by printing are separately prepared. Then, the inner electrode layers can be formed by printing using a printer that can separately perform printing with two types of screen plates.

A stacked sheet is produced using the dielectric sheets on which the inner electrode patterns have been formed. That is, a predetermined number of the dielectric sheets for the outer layers on which none of the inner electrode patterns are formed are stacked, thus forming a portion to be formed into the first outer layer portion 515b1 on the side of the first main surface 512a. The dielectric sheets on which the inner electrode pattern corresponding to the first inner electrode layers 516a has been formed and the dielectric sheets on which the inner electrode pattern corresponding to the second inner electrode layers 516b has been formed are alternately stacked thereon, thus forming a portion to be formed into the effective layer portion 515a. A predetermined number of the dielectric sheets for the outer layers on which none of the inner electrode patterns are formed are stacked thereon, thus forming a portion to be formed into the second outer layer portion 515b2. In this way, the stacked sheet is produced.

The stacked sheet is pressed in the lamination direction by, for example, an isostatic press, to produce a laminated block.

The laminated block is cut into laminated chips with a predetermined size.

Barrel polishing is then performed to form laminated chips having a desired shape.

Specifically, the diameter of the media in barrel polishing is preferably about 0.2 mm or more and about 0.7 mm or less, for example. The amount of the media is preferably about 200 cc or more and about 700 cc or less, for example. The rotation is performed not only in one direction but also in multiple directions. In this way, barrel polishing is performed until the all end surfaces of the laminated chips have a desired rounded shape. It is preferable that the diameter of the media be adjusted in accordance with the dimension T and that sandblasting be performed in addition to the barrel polishing.

The laminated chips are fired to produce the multilayer bodies 512. The firing temperature depends on the ceramic material and the material of the inner electrode layers, but is preferably, for example, about 900° C. or higher and about 1, 400° C. or lower.

Subsequently, the underlying electrode layers 526 and 527 are formed on a portion of each of the first main surface 512a, the second main surface 512b, the first side surface 512c, the second side surface 512d, the third side surface 512e, and the fourth side surface 512f of the multilayer body 512.

Case where Underlying Electrode Layers Are Baked Layers

A conductive paste to be formed into an underlying electrode layer is applied to a portion of each of the first side surface 512c, the second side surface 512d, the third side surface 512e, and the fourth side surface 512f of the multilayer body 512 to form the first underlying electrode layer 526a and the second underlying electrode layer 526b of the underlying electrode layers 526, and the third underlying electrode layer 527a and the fourth underlying electrode layer 527b of the underlying electrode layers 527.

In the case of forming the baked layers, a conductive paste including a glass component and a metal is applied by a method, such as dipping, and then subjected to baking treatment, thus forming the underlying electrode layers. In this case, the baking treatment temperature is preferably, for example, about 700° C. or higher and about 900° C. or lower.

Furthermore, by using the dipping method, it is possible to form a layer to extend not only to any one of the first side surface 512c, the second side surface 512d, the third side surface 512e, and the fourth side surface 512f, which are the application targets, but also to portions of the first main surface 512a, the second main surface 512b, these side surfaces or the side surfaces adjacent to the main surfaces.

### Case Where Underlying Electrode Layers Are Thin Film Layers

When the underlying electrode layers are formed of thin film layers, masking or the like is performed, and underlying electrode layers 526 and 527 are formed by a thin film formation method, such as sputtering or vapor deposition, at the locations where the outer electrodes 524 and 525 are to be formed.

The underlying electrode layers 526 and 527 formed of thin film layers are layers having deposited metal particles and having a thickness of about 1 μm or less, for example.

At this time, the thin film layers are preferably bonded to the direct plating layers arranged so as to be bonded to the inner electrode layers 516.

### Case Where Underlying Electrode Layers Are Fired Electrode Layers

When the underlying electrode layers are formed of fired electrode layers, before firing the laminated chip, the underlying electrode layers made of the fired electrode layers are arranged at desired positions on each of the first main surface 512a, the second main surface 512b, the first side surface 512c, the second side surface 512d, the third side surface 512e, and the fourth side surface 512f by, for example, a screen printing method. Then the laminated chip is fired.

The firing temperature at this time is preferably about 700° C. or higher and about 1, 400° C. or lower, for example. When the laminated chip and the fired electrode layers are fired simultaneously, the contact between the laminated chip and the fired electrode layers are improved, and peeling is less likely to occur.

For example, when the underlying electrode layers, which are the fired electrode layers, are formed by screen printing, the underlying electrode layers are preferably bonded to direct plating layers arranged so as to be bonded to the inner electrode layers 516. In this case, the underlying electrode layers, which are the fired electrode layers formed by screen printing, may have the same components as the inner electrode layers 516. In the case of the same components, as described above, the multilayer chip may be fired after the underlying electrode layers are arranged, or baking treatment may be performed after the multilayer body 512 is fired.

Finally, plating layers are formed. The plating layers may be formed on the surfaces of the underlying electrode layers or may be formed directly on the multilayer body. More specifically, a Ni plating layer (lower plating layer) and a Sn plating layer are formed over each underlying electrode layer. In the plating treatment, either electrolytic plating or electroless plating may be used. Electroless plating has the disadvantage that pretreatment with a catalyst or the like is required to improve the plating deposition speed, making the process complicated. Therefore, it is usually preferable to use electrolytic plating.

As described above, the multilayer ceramic capacitor 510 illustrated in FIG. 7 can be manufactured. In the example method for manufacturing the multilayer

ceramic capacitor according to the present example embodiment as described above, it is possible to manufacture the high-quality multilayer ceramic capacitor according to the present invention, the multilayer ceramic capacitor having high moisture resistance reliability, improved bonding strength between the conductive component of the outer electrodes and the inner electrodes, and a reduced ESR.

### C. Experimental Examples

According to the manufacturing method of the first example embodiment described above, multilayer ceramic capacitors as non-limiting samples were produced and then subjected to an ESR test.

### (a) Specification of Sample for Experimental Example

As experimental examples, multilayer ceramic capacitors having the structure illustrated in FIGS. 1 to 3 and having the following specifications were prepared.
Ceramic material: BaTiO₃
Electrostatic capacitance: 220 nF
Rated voltage: 4 V
Structure of outer electrode

Underlying electrode layer: Electrode including conductive metal (Cu) and glass component

Thickness of underlying electrode layer at central portion in length direction of underlying electrode layer located on first main surface, second main surface, first side surface, and second side surface: 3 μm

Metal layer formed of plating layer: two-layer formation of Ni plating layer +Sn plating layer

Thickness of Ni plating layer: thickness of Ni plating layer at central portion in length direction of Ni plating layer located on first main surface, second main surface, first side surface, and second side surface: 3 μm

Thickness of Sn plating layer: thickness of Sn plating layer at central portion in length direction of Sn plating layer located on first main surface, second main surface, first side surface, and second side surface: 3 μm

Before the formation of the underlying electrode layers, in Sample Nos. 2 to 6, as given in Table 1, multilayer bodies having different radii of curvature of end surfaces and thus having different degrees of curvature of the end surfaces were prepared.

Thereafter, underlying electrode layers (Cu) were formed on the multilayer bodies of Sample Nos. 1 to 6 before the formation of the outer electrodes. Then Ni plating layers and Sn plating layers were formed, thus preparing multilayer ceramic capacitors as samples of Sample Nos. 1 to 6.

### (b) ESR Test

The ESR was measured by subjecting each sample multilayer ceramic capacitor to heat treatment in an air atmosphere at 150° C. for 1 hour before the measurement, and then mounting the capacitor on a measurement substrate. At 24±2 hours after the completion of the heat treatment, the ESR was measured using a network analyzer at a measurement frequency of 1 MHZ. One hundred pieces were measured, and the average value was used as the value in the table. Sample No. 1 was used as a reference, and the following were used to determine whether the ESR was good or poor.
o: not more than 97% of ESR of Sample No. 1
-: more than 97% of the ESR of Sample No. 1

### (c) Results

Table 1 presents the results of the ESR test for Sample Nos. 1 to 6.

TABLE 1

| Sample No. | 1 | 2 | 3 | 4 | 5 | 6 |
|---|---|---|---|---|---|---|
| Dimension L of | 600 | 600 | 599 | 599 | 598 | 600 |
| multilayer | | | | | | |
| ceramic capacitor (μm) | | | | | | |
| Dimension W of | 300 | 300 | 300 | 298 | 300 | 297 |
| multilayer | | | | | | |
| ceramic capacitor (μm) | | | | | | |
| Dimension T | 59 | 59 | 57 | 58 | 60 | 60 |
| of multilayer | | | | | | |
| body (μm) | | | | | | |
| Radius of curvature | almost ∞ | 153 | 124 | 88 | 58 | 30 |
| of end surface | | | | | | |
| ESR evaluation | reference | — | ○ | ○ | ○ | ○ |

As presented in Table 1, in each of the samples of Sample Nos. 3 to 6, the radius of curvature was about 5/2 or less of the thickness dimension of the multilayer body 12 in the height direction x at the central portion of the multilayer body 12 in the length direction z. Therefore, a good ESR measurement result of about 97% or less with respect to the ESR of Sample No. 1 was obtained.

In contrast, for Sample No. 2, the radius of curvature was about 5/2 or more of the thickness dimension of the multilayer body 12 in the height direction x at the central portion of the multilayer body 12 in the length direction z. Therefore, the measurement result of the ESR was more than about 97% of the ESR of Sample No. 1.

As described above, in each of the samples of Sample Nos. 3 to 6, the first end surface 12e and the second end surface 12f of the multilayer body 12 were each curved from the first main surface 12a to the second main surface 12b, and the radius of curvature thereof was about 5/2 or less of the thickness dimension of the multilayer body 12 in the height direction x at the central portion of the multilayer body 12 in the length direction z. Accordingly, the inner electrode layers 16 had increased exposed areas on the first end surface 12e and the second end surface 12f, thus resulting in increased bonding strength between the multilayer body 12 and the conductive component of the outer electrodes 24. Furthermore, because of the increased exposed areas of the conductive component of the outer electrodes 24, the effect of controlling ESR to a low level can be provided.

Although the multilayer ceramic electronic component having a laterally symmetrical shape in front view has been exclusively illustrated in the above-example embodiments and each modification, the outer shape of multilayer ceramic electronic components according to example embodiments of the present invention can be variously changed in accordance with a target on which the component is to be mounted and in accordance with required performance. Furthermore, example embodiments of the present invention also include an appropriate combination of all or a portion of the configurations of the above-described example embodiments and each modification.

For example, the first main surface 12a of the multilayer body 12 of the multilayer ceramic capacitor 10 may be curved from the first side surface 12c to the second side surface 12d, or may be curved from the first end surface 12e to the second end surface 12f. Similarly, the second main surface 12b of the multilayer body 12 may be curved from the first side surface 12c to the second side surface 12d, or may be curved from the first end surface 12e to the second end surface 12f.

Furthermore, the first main surface 512a of the multilayer body 512 of the multilayer ceramic capacitor 510 may be curved from the first side surface 512c to the second side surface 512d, or may be curved from the third side surface 512e to the fourth side surface 512f. Similarly, the second main surface 512b of the multilayer body 512 may be curved from the first side surface 512c to the second side surface 512d, or may be curved from the third side surface 512e to the fourth side surface 512f.

That is, various changes can be made regarding a mechanism, a shape, a material, a quantity, a position, an arrangement, and the like for the example embodiments and each modification described above without departing from the scope of the present invention.

Example embodiments of the present invention relate to multilayer ceramic capacitors. In particular, the multilayer ceramic capacitor can be used as a multilayer ceramic capacitor with outer electrodes each having a multilayer structure.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including a first main surface and a second main surface opposite each other in a height direction, the height direction being a lamination direction of the dielectric layers, a first side surface and a second side surface opposite each other in a width direction perpendicular to the height direction, a third side surface and a fourth side surface opposite each other in a length direction perpendicular to the height direction and the width direction, first inner electrode layers laminated with dielectric layers and exposed on at least two or more of the first side surface, the second side surface, the third side surface, or the fourth side surface, and second inner electrode layers laminated with the dielectric layers and exposed on at least two or more of the first side surface, the second side surface, the third side surface, or the fourth side surface;
a first outer electrode connected to the first inner electrode layers; and
a second outer electrode connected to the second inner electrode layers; wherein
each of the first side surface, the second side surface, the third side surface, and the fourth side surface is curved from the first main surface to the second main surface.

2. The multilayer ceramic capacitor according to claim 1, wherein the first main surface is curved across each of the first side surface, the second side surface, the third side surface, and the fourth side surface.

3. The multilayer ceramic capacitor according to claim 1, wherein a first dummy electrode layer is disposed on an extension line of a first extension electrode portion of each of the first inner electrode layers in the height direction.

4. The multilayer ceramic capacitor according to claim 1, wherein a thickness of the multilayer body in the height direction is about 300 μm or less.

5. The multilayer ceramic capacitor according to claim 4, wherein the first outer electrode includes:
a first thin film layer on the first main surface; and
a first direct plating layer connected to the first inner electrode layers and covering a portion of the first thin film layer; and
the second outer electrode includes:
a second thin film layer on the first main surface; and
a second direct plating layer connected to the second inner electrode layers and covering a portion of the second thin film layer.

6. The multilayer ceramic capacitor according to claim 5, wherein each of the first thin film layer and the second thin film layer extend from the first main surface to a portion of each of the first side surface, the second side surface, the third side surface, and the fourth side surface.

7. The multilayer ceramic capacitor according to claim 6, wherein the first thin film layer and the second thin film layer are directly connected to at least one of the first inner electrode layers and the second inner electrode layers.

8. The multilayer ceramic capacitor according to claim 4, wherein the first outer electrode includes:
first fired electrode layers each located on the first main surface or the second main surface and including a metal component and a dielectric material; and
a first underlying electrode layer connected to the first inner electrode layers, the first underlying electrode layer covering a portion of each of the first fired electrode layers; and
the second outer electrode includes:
second fired electrode layers each located on the first main surface or the second main surface and including a metal component and a dielectric material; and
a second underlying electrode layer connected to the second inner electrode layers, the second underlying electrode layer covering a portion of each of the second fired electrode layers.

9. The multilayer ceramic capacitor according to claim 8, wherein the first fired electrode layers and the second fired electrode layers are each discontinuously provided in the length direction or the width direction.

10. The multilayer ceramic capacitor according to claim 8, wherein the first fired electrode layers are located on the first side surface, the second side surface, the third side surface, and the fourth side surface, and the second fired electrode layers are located on the first side surface, the second side surface, the third side surface, and the fourth side surface.

11. A multilayer ceramic capacitor, comprising:
a multilayer body including a first main surface and a second main surface opposite each other in a height direction, the height direction being a lamination direction of the dielectric layers, a first side surface and a second side surface opposite each other in a width direction perpendicular to the height direction, a third side surface and a fourth side surface opposite each other in a length direction perpendicular to the height direction and the width direction, first inner electrode layers laminated with dielectric layers and exposed on at least two or more of the first side surface, the second side surface, the third side surface, or the fourth side surface, and second inner electrode layers laminated with the dielectric layers and exposed on at least two or more of the first side surface, the second side surface, the third side surface, or the fourth side surface;
a first outer electrode connected to the first inner electrode layers; and
a second outer electrode connected to the second inner electrode layers; wherein
the first main surface is curved across each of the first side surface, the second side surface, the third side surface, and the fourth side surface.

12. The multilayer ceramic capacitor according to claim 11, wherein the second main surface is curved across each of the first side surface, the second side surface, the third side surface, and the fourth side surface.

13. The multilayer ceramic capacitor according to claim 11, wherein a first dummy electrode layer is disposed on an extension line of a first extension electrode portion of each of the first inner electrode layers in the height direction.

14. The multilayer ceramic capacitor according to claim 13, wherein a second dummy electrode layer is disposed on an extension line of a second extension electrode portion of each of the first inner electrode layers in the height direction.

15. The multilayer ceramic capacitor according to claim 13, wherein the first outer electrode includes first fired electrode layers each located on the first main surface or the second main surface and including a metal component and a dielectric material.

16. The multilayer ceramic capacitor according to claim 13, wherein the first outer electrode includes first direct plating layers each directly connected to the first inner electrode and the first dummy electrode.

17. The multilayer ceramic capacitor according to claim 15, wherein the first outer electrode includes first direct plating layers each directly connected to the first inner electrode, the first dummy electrode, and the first fired electrode.

18. The multilayer ceramic capacitor according to claim 13, wherein the first main surface is curved across each of the first side surface, the second side surface, the third side surface, and the fourth side surface.

19. The multilayer ceramic capacitor according to claim 15, wherein the first main surface is curved across each of the first side surface, the second side surface, the third side surface, and the fourth side surface.
